(19) United States
(12) Patent Application Publication
(10) Pub. No.: US 2014/0058799 A1
(43) Pub. Date: Feb. 27, 2014

(54) SCENARIO PLANNING GUIDANCE

(71) Applicant: Chakradhar Gottemukkala, Austin, TX (US)

(72) Inventor: Chakradhar Gottemukkala, Austin, TX (US)

(21) Appl. No.: 13/594,766

(22) Filed: Aug. 24, 2012

(51) Int. Cl. G06Q 10/06

(52) U.S. Cl. 705/7.37

(57) ABSTRACT

One or more plan models are identified, each of the plan models representing a business outcome of a corresponding domain and including a respective set of input drivers and a respective set of outcome measures, where values of the outcome measures are influenced by values of the input drivers. One or more particular values are received in connection with a scenario based on the plan models and one or more guidance rules, defined through the plan models, are applied to values of the scenario. In some instances, each plan model includes a respective input drivers model defining input drivers of the plan model, a respective outcome measures model defining outcome measures of the plan model, and one or more guidance rules defining constraints on values of input drivers and/or outcome measures of the plan model.

### TECHNICAL FIELD

This disclosure relates in general to the field of computer software modeling and, more particularly, to business outcome modeling.

### BACKGROUND

Modern enterprises are competing in global markets that are increasingly complex and dynamic. A single enterprise may have a multitude of different departments, managers, and assignments, each having their own respective objectives, plans, and goals commensurate with their respective roles within the enterprise. Additionally, a single enterprise may have one or more enterprise-wide goals that involve the collaboration and involvement of its different departments, managers, and business units. For each goal, an enterprise may develop a plan for realizing the goal. A variety of different paths may exist for reaching the goal and a plan can establish which of these paths will be followed, such as defined by the particular activities, inputs, and steps the enterprise will adopt in pursuing its goal. Because a variety of potential paths may be adopted by an enterprise to reach its goal, planning can involve determining which of the path(s) are most desirable or optimal for the particular enterprise. Additionally, planning can involve the modification or replacement of previously-adopted plans based on changed conditions within the enterprise, the market place, or geopolitical landscape in which the enterprise exists.

### BRIEF DESCRIPTION OF DRAWINGS

FIG. 1 is a simplified schematic diagram of an example computing system adapted to provide one or more example plan modes;

FIG. 2 is a simplified block diagram of an example system including an example plan model engine;

FIG. 3 is a simplified block diagram representing principles of an example plan model;

FIG. 4 is a simplified block diagram representing an example instance of a plan model;

FIGS. 5A-5I are simplified block diagrams illustrating example features and models of an example scope model of an example plan model;

FIG. 6A is a simplified block diagram illustrating an example outcome measures model of an example plan model;

FIG. 6B is a simplified block diagram illustrating an example input drivers model of an example plan model;

FIGS. 7A-7B are simplified representations of outcome measure guidance in connection with an example plan model;

FIGS. 8A-8B are simplified representations of input driver guidance in connection with an example plan model;

FIGS. 9A-9D are simplified block diagrams illustrating example features of an example sensitivity model of an example plan model;

FIG. 10A is a simplified block diagram illustrating an example process model of an example plan model;

FIG. 10B is a simplified block diagram representing a set of plan model activities defined using example process models of the respective plan models;

FIGS. 11A-11B are simplified block diagrams illustrating example networks of plan models;

FIG. 12A is a simplified block diagram illustrating principles of input driver scenario planning utilizing one or more plan models;

FIG. 12B is a simplified block diagram illustrating principles of goal-based scenario planning utilizing one or more plan models;

FIGS. 13A-13H are screenshots of example user interfaces for use in connection with one or more example plan models;

FIGS. 14A-14C are flowcharts of example techniques for using an example plan model in accordance with at least some embodiments.

Like reference numbers and designations in the various drawings indicate like elements.

### SUMMARY

In general, one aspect of the subject matter described in this specification can be embodied in methods that include the actions of identifying a plan model adapted to model business outcomes for a particular domain, the plan model including a scope model defining the particular domain. A value can be identified of at least one of a set including input drivers and outcome measures of the plan model. A scenario can be generated from the plan model for the particular domain based on the identified value.

In another general aspect, a computer program product, encoded on a non-transitory, machine readable storage medium can be provided and include one or more plan models, each plan model representing a respective business outcome expressed as one or more respective outcome measures. Each plan model can include one or more input drivers representing variables influencing the one or more outcome measures, a scope model defining a domain of the plan model to which the business outcome applies, and a sensitivity model corresponding to the domain and defining one or more dependencies between the input drivers and outcome measures.

In another general aspect of the subject matter described in this specification can be embodied in systems that include at least one processor device, at least one memory element, one or more plan models, and a plan model engine. Each plan model can model outcomes of a respective domain and include one or more input drivers and one or more outcome measures, the values of the outcome measures at least partially dependent on values of the input drivers. The plan model engine, when executed by the at least one processor device, can identify a particular one of the plan models, identify a particular value of one of the input drivers and outcome measures of the particular plan model, and use the one or more plan models to generate a scenario based on the particular value.

These and other embodiments can each optionally include one or more of the following features. The scope model can include an included entities model defining a set of entities in the domain, and the particular domain can represent an intersection between the set of entities. Each of the one or more included entities can include at least one member and the scope model can further include, for each included entity in the set of entities, a respective included members model defining members of the corresponding entity included in the domain. Each included member can be of a respective one of a plurality of member types and each member type can have a respective set of member type attributes. The plan model can further include, for each included entity, an included hierarchies model modeling hierarchies of member sets of each entity included in the domain. A particular one of the entities can have two or more hierarchies of member sets of the particular entity and members of each set of members can share a common value for at least one attribute of one or more member types. Each plan model can further include a process model defining a business process of the corresponding plan model and including a planning activity model modeling activities associated with usage of the plan model, a frequency model identifying timing information for each of the activities, and a responsibility model identifying, for each activity, responsibilities of users with respect to the activity. A version model can manage one or more versions of one or more scenarios of one or more plan models.

Further, these and other embodiments can also each optionally include one or more of the following features. Each plan model can be adapted to interconnect with at least one other plan model and interconnections between plan models can be defined by link expressions each specifying a respective dependency between two or more respective plan models. Plan models can further include at least one input driver model modeling input drivers of the plan model, and at least one outcome measure model modeling outcome measures of the plan model. The plan model can also include a goal model defining a minimize/maximize property for each outcome measure, a relative priority property for one or more of the outcome measures, and a threshold property for each outcome measure. Sensitivity models can include one or more correlation models defining dependencies of the outcome measures on input drivers of the corresponding plan model and further include a propagation model defining an order of effects to values of input drivers and outcome measures resulting, at least in part, from changes to values of a corresponding one of the input drivers or outcome measures. At least one sensitivity model can include correlation models defining at least one of: dependencies between input drivers on other input drivers, and dependencies between outcome measures on other outcome measures. Further, at least some of the correlation models can define formulas representing the dependencies and a particular one of the correlation models can define a dependency between a particular input driver and particular outcome measure lacking a formula for the dependency, and can cause a request for an input value for one of the particular input driver and particular outcome measure, for instance, from a user.

Further, these and other embodiments can also each optionally include one or more of the following features. An identified value can be a value of a particular one of the input drivers and generating the scenario can include a generated value of at least one of the outcome measures based on the value of the particular input driver. A graphical representation of the scenario can be presented on a user interface of a display device. The generated scenario can be a first version of a particular scenario and the graphical representation can include a comparison of the first version of the particular scenario with one or more other versions of the particular scenario. The value can be a value of a particular one of the outcome measures and generating the scenario can include generating a value of at least one of the input drivers based on the value of the particular outcome measure. A plurality of scenarios can be generated based on the value of the particular outcome measure in some instances. The values of the input drivers can be generated based at least in part on a goal model of the plan model. Identifying the value can include at least one of receiving the value from a user, receiving the value from an application accessing the plan model, and linking to another plan model. Identifying the plan model can include generating a new plan model, selecting the plan model from a plurality of available plan models, and identifying the plan model from a selected scenario. A scope model identifying hierarchies of member sets included in the domain can be used to represent the value at one of a plurality of levels of aggregation based on the included hierarchies of the domain. The plan models can be part of a plurality of interconnected plan models and the plurality of plan models can be used to generate the scenario.

Indeed, in another general aspect, methods can include identifying a focus plan model in a network of plan models including two or more plan models, each plan model in the network of plan models representing outcomes for a respective domain, the outcomes for each domain influenced by a respective set of input drivers of the corresponding plan model. One or more linked plan models can be identified in the network of plan models that are linked to the focus plan model, link expressions defining links between the plan models. One or more values of the focus plan model can be identified, the one or more values including a value of at least one of a set including the input drivers of the focus plan model and outcome measures of the focus plan model. A scenario can be generated based on the identified value using both the focus plan model and the one or more linked plan models.

In another general aspect, a computer program product, encoded on a non-transitory, machine readable storage medium can be provided and include a first plan model adapted to represent outcomes in a first domain and including a first set of input drivers and a first set of outcome measures, a second plan model adapted to represent outcomes in a second domain and including a second set of input drivers and a second set of outcome measures, and at least one link expression defining a link between a particular outcome measure of the first set of outcome measures and a particular input driver of the second set of input drivers.

In another general aspect of the subject matter described in this specification can be embodied in systems that include at least one processor device, at least one memory element, a first plan model, a second plan model, a link expression defining a link between the first and second plan models, and a plan model engine. The first plan model can be stored in the at least one memory element and be adapted to represent outcomes in a first domain and can include a first set of input drivers and a first set of outcome measures. The second plan model can be stored in the at least one memory element and adapted to represent outcomes in a second domain and can include a second set of input drivers and a second set of outcome measures. The link expression can be stored in the at least one memory element and define a link between a particular outcome measure of the first set of outcome measures and a particular input driver of the second set of input drivers. The plan model engine can be adapted, when executed by the processor, to identify a particular value of one of the input drivers of the first set of input drivers and outcome measures of the second set of outcome measures and use the first and second plan models to generate a scenario based on the particular value and the link expression.

These and other embodiments can each optionally include one or more of the following features. The network of plan models can model decision factors and goals of a particular organization. A particular one of the link expressions can define a dependency of a particular input driver of the focus model on a particular outcome measure of a particular one of the linked models. A particular one of the link expressions can alternatively define a dependency of a particular input driver of a particular one of the linked models on a particular outcome measure of the focus model. The link expressions can include a plurality of link expressions, at least one of the link expressions defining a dependency of one of the input drivers of the focus model on one of the outcome measures of one of the linked plan models and another one of the link expressions defining a dependency of one of the input drivers of another one of the linked plan models on one of the outcome measures of the focus plan model. At a first instance, the focus plan model can be a first plan model in the network of plan models and the one or more linked plan models can include a second plan model in the network of plan models. The second plan model can be thus identified as a focus plan model at a second instance and the first plan model can be identified as a linked plan model of the second plan model. Each domain can be associated with a corresponding set of users and access to the corresponding plan model can be limited to the set of users associated with the domain of the plan model. Each plan model in the network plan models can be adapted for use in generating a different scenario independent of other plan models. Values of each plan model are adapted to be represented at respective levels of aggregation as defined in the respective plan model.

Further, these and other embodiments can also each optionally include one or more of the following features. Generating the scenario can include use of an ask-response-consensus protocol and include the causing of at least one target value for a particular outcome measure of a particular linked plan model to be asked by the focus plan model. At least one response to the requested target value from the particular linked plan model can be identified and a consensus value can be determined for the particular outcome measure based, at least in part, on the requested target value and the response. The consensus value can be the target value. The response can include information describing an effect of adopting the target value. The consensus value can be a value other than the target value. The target value can include a plurality of target values, and the at least one response can include a plurality of responses to the plurality of target values, the consensus value determined through an iterative process including the plurality of target values and plurality of responses. Link expressions can include a particular link expression defining a dependency of a particular one of the input drivers of the particular linked plan model on a particular one of the outcome measures of the focus plan model. Generating the scenario can include automated propagation of values from the focus plan model to the linked plan model, the value including a value of a particular one of the input drivers of the focus plan model and causing generation of a value for a particular one of the outcome measures of a particular one of the one or more linked plan models generated through the automated propagation from the particular input driver of the first focus plan model to the particular outcome measure of the particular linked plan model based at least in part on the particular link expression. Alternatively, the particular link expression can define a dependency of a particular one of the input drivers of the focus plan model on a particular one of the outcome measures of the particular linked plan model, and generating the scenario can include automated propagation of values from the focus plan model to the linked plan model, where the value includes a value of a particular one of the outcome measures of the focus plan model and causes generation of a value for a particular one of the input drivers of a particular one of the linked plan models generated through the automated propagation from the particular outcome measure of the focus plan model to the particular input driver of the particular linked plan model based at least in part on the particular link expression. Indeed, in a network of plan model including first and second plan models, either the first or second plan model can be designated as a focus plan model in a planning session, and designating the first plan model as the focus plan model causes the second plan model to be identified as a linked plan model of the first plan model and designating the second plan model as the focus plan model causes the first plan model to be identified as a linked plan model of the second plan model.

In another general aspect of the subject matter described in this specification can be embodied in methods including the actions of identifying one or more plan models, each of the plan models representing a business outcome of a corresponding domain and including a respective set of input drivers and a respective set of outcome measures, where values of the outcome measures are influenced by values of the input drivers. One or more particular values can be received in connection with a scenario based on the plan models. One or more guidance rules defined through the plan models can be applied to values of the scenario.

In another general aspect, a computer program product, encoded on a tangible, non-transitory, machine readable storage medium can include one or more plan models, each plan model adapted to model outcomes for a respective business domain and including an input drivers model defining input drivers of the plan model, an outcome measures model defining outcome measures of the plan model, and one or more guidance rules defining constraints on values of at least one of a particular input driver of the plan model and a particular outcome measures of the plan model. In some instances, computer program products can further include a second plan model adapted to model outcomes for a second business domain, and at least one link expression defining a dependency between the first plan model and the second plan model.

In another general aspect of the subject matter described in this specification can be embodied in systems that include at least one processor device, at least one memory element, at least one plan model, and a plan model engine. The plan model can be stored at the memory element and adapted to model outcomes for a particular business domain. The plan model can further include an input drivers model defining input drivers of the plan model, an outcome measures model defining outcome measures of the plan model, and one or more guidance models defining guidance rules for values of at least one of a particular input driver of the plan model and/or a particular outcome measure of the plan model. The plan model can be adapted, when executed by the processor, to generate scenarios based on the plan model and apply the defined guidance rules to the scenarios.

These and other embodiments can each optionally include one or more of the following features. Applying the particular guidance rule can constrain the specified value according to the particular guidance rule. Applying the particular guidance rule can further, or alternatively, include presentation of an indication of a degree of compliance with the particular guidance rule. The indication, in some instances, can be a warning of a violation of the particular guidance rule. Applying the particular guidance rules can further include presentation of an indication of a target value for an outcome measure or input driver. The one or more particular values can include a specified value of a particular one of the set of input drivers of a particular one of the one or more plan models and a particular guidance rule of the particular plan model can be applied to the specified value. The particular input driver guidance rule can include a feasibility guidance rule defining one of a lower bound or upper bound for values of the particular input driver, a benchmark guidance rule specifying at least one benchmark value for values of the particular input driver, and/or a relative importance indicator for the particular input driver relative to at least one other input driver in the particular plan model. In other instances, the one or more particular values can include a value of a particular one of the set of outcome measures of a particular one of the one or more plan models and a particular guidance rule of the particular plan model can be applied to the value of the particular outcome measure. The particular outcome measure guidance rule can include, for example, a benchmark guidance rule specifying at least one benchmark value for values of the particular outcome measure. Benchmark values can include at least one of a set including a best-in-class value, a median value, a worst-in-class value, and competitive rank values.

Further, these and other embodiments can also each optionally include one or more of the following features. Parameters of the one or more guidance rules can be defined based on a received input. Defining the parameters can include modifying previous parameters of the one or more guidance rules based on the received input. The plan model can be a first plan model that is linked to a second plan model, and the scenario can be based at least on the first and second plan models, and the guidance rules can be applied to values of each of the first and second plan models. Guidance rules of the first plan model can be applied to values of the first plan model and guidance rules of the second plan model can be applied to values of the second plan model.

Some or all of the features may be computer-implemented methods or further included in respective systems or other devices for performing this described functionality. The details of these and other features, aspects, and implementations of the present disclosure are set forth in the accompanying drawings and the description below. Other features, objects, and advantages of the disclosure will be apparent from the description and drawings, and from the claims.

### DETAILED DESCRIPTION

Modern enterprises can often include complex organizations, such as large multinational corporations with multiple business units and departments operating in multiple different countries, as well as organizations competing in multiple different marketplaces, including multiple product markets and geographical markets, among other examples. Organization can also include stock and commodity markets and exchanges, non-profit organizations, charities, religious organization, educational institutions, joint-ventures, market segments, trade associations, and so on. Such organizations can adopt a variety of goals and plans in connection with their respective operation, including for-profit and not-for-profit goals. Planning and decision-making activities in connection with these goals has become increasingly complex. For instance, such goals can be set at various levels within the organization, including at the organization level (i.e., goals that apply to the entire organization) as well as at various sub-levels, such as the business unit sub-level, the department sub-level, the region sub-level, the office sub-level, etc. Sub-level goals may be limited in their scope to their respective sub-part of the organization and may only concern a subset of people within the organization. Further, some goals may be limited temporally, such as goals that apply to a certain period (such as a financial year or quarter). Regardless of the level or type of goal, plans can be adopted by the organization or portion of the organization for accomplishing these goals. In some instances, plans and goals of different sub-parts of an organization can conflict and the amount of time needed to communicate and synchronize plans and goals can prevent adequate collaboration and coordination within the organization. Further, a plan may involve setting targets for a variety of inputs relating to a variety of different business entities. The inputs may include values quantifying or defining attributes of the respective business entities relevant to the goal and plan. Such business entities can include such entities as product categories, distribution channels, supply channels, customers, products, fiscal calendar terms, geographic regions and sub-regions, etc.

Software-based models and systems can be developed that model plans, goals, and outcomes within an organization. Such “plan models” can be accessed and used by systems and users to assist in improving an organization's (or group of organizations') planning activities, as well as the realization of the goals associated with its planning activities. A set of plan models can be provided, each plan model corresponding to a defined domain relevant to an organization and modeling aspects of that domain as well as the inputs and outcomes relevant to achieving or analyzing goals of the specified domain. Plan models can be used to enable interactive, quick, collaborative decision-making within an organization, including along particular user or department roles and functions. Plan models can be used, for example, to assess, generate, and modify plans and goals within the organization to increase the overall success of the organization. For instance, plan models can be interlinked to model the interconnectedness of some plans and goals of an organization. Plan models can be used to coordinate the efforts of various portions of an organization directed to different goals to optimize the activities of an organization. Additionally, scenario planning can be carried out using such plan models, with business scenarios of the organization being modeled and compared based on the plan models. Additionally, plan models and business scenarios based on plan models can provide decision-makers of an organization with views into the business entities and attributes relevant to the organization's goals, including views at various levels of abstraction and detail. In general, such plan model and business scenarios can be used to guide the direction of real-world departments and business of an organization, whether for-profit or not-for-profit, to assist in the achieving of the organization's (or multiple organizations') varied goals.

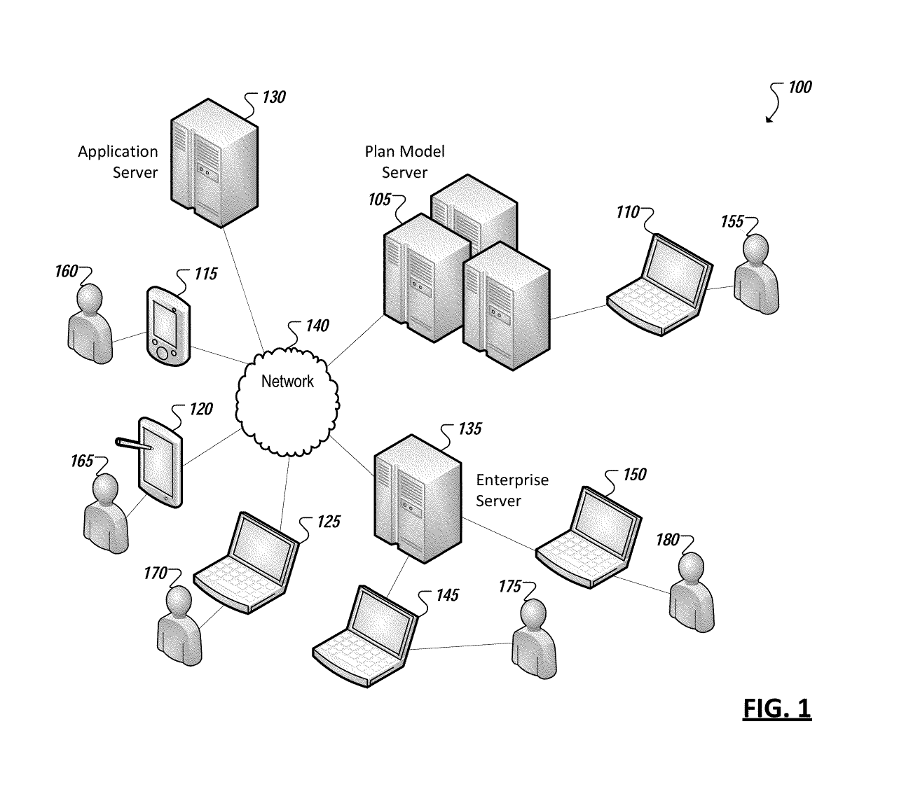

FIG. 1 is a simplified block diagram illustrating an example implementation of a computing system 100 including a plan model system 105 capable of generating, maintaining, and serving a plurality of plan models to potentially several different clients. Additionally, a plan model system 105 can further include programs, tools, and functionality allowing clients to access and interact with plan models, including the editing of plan models, building of plan models, linking of plan models, scenario building using plan models, among other functionality and tools, including those discussed explicitly or implicitly herein. Client computing devices can include endpoint user devices (e.g., 110, 115, 120, 125, 145, 150) that can include display devices and user interfaces allowing users (e.g., 155, 160, 165, 170, 175, 180) to interact with plan model system 105, plan models hosted or provided by the plan model system 105, and applications, programs, and services hosted or provided by the plan model system that allow users to interact with, edit, build, generate and compare scenarios from the plan models, as well as analyze, and generate working business plans for the organization from the plan models. In some instances, client computing devices can include endpoint devices (e.g., 110) local to the plan model system 105 allowing administrators, model developers, and other users (e.g., 155) to develop and maintain plan models and plan model tools hosted or provided by the plan model system 105. Endpoint devices can also include computing devices remote from at least a portion of the plan model system 105 and accessing plan model system resources, such as plan model interaction tools and plan models, from the plan model system 105 over one or more networks (e.g., 140). In some implementations all or a portion of the plan model system 105 can be distributed to or implemented on clients (e.g., 110, 115, 120, 125, 145, 150), such as client-specific plan models, software tools for use by clients in interacting with and using plan models, etc.

In addition to endpoint devices, other systems can also act as clients of plan model system 105. For instance, application servers (e.g., 130) hosting one or more applications, services, and other software-based resources can access and use plan models and functionality of plan model system 105 in connection with the applications and services hosted by the application server (e.g., 130). Enterprise computing systems (e.g., 135) can also interface with and use plan models and services of an example plan model system 105. For instance, enterprise-specific plan models can be developed and used by endpoint devices (e.g., 145, 150) within the enterprise. In some instances, other enterprise tools and software can be provided through enterprise computing system 135 and consume data provided through plan models and plan-model-related services of the plan model system 105, among other examples.

In general, “servers,” “clients,” and “computing devices,” including computing devices in example system 100 (e.g., 105, 110, 115, 120, 125, 130, 135, 145, 150, etc.), can include electronic computing devices operable to receive, transmit, process, store, or manage data and information associated with computing system 100. As used in this document, the term “computer,” “computing device,” “processor,” or “processing device” is intended to encompass any suitable processing device. For example, the system 100 may be implemented using computers other than servers, including server pools. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, and computing devices (e.g., 105, 110, 115, 120, 125, 130, 135, 145, 150, etc.) can each include one or more processors, computer-readable memory, and one or more interfaces, among other features and hardware. Servers can include any suitable software component or module, or computing device(s) capable of hosting and/or serving software applications and services (e.g., plan models and plan model applications and services of the plan model system 105, applications and services of application server 130, applications and services of enterprise system 135, etc.), including distributed, enterprise, or cloud-based software applications, data, and services. For instance, servers can be configured to host, serve, or otherwise manage models and data structures, data sets, software service and applications interfacing, coordinating with, or dependent on or used by other services and devices. In some instances, a server, system, subsystem, or computing device can be implemented as some combination of devices that can be hosted on a common computing system, server, server pool, or cloud computing environment and share computing resources, including shared memory, processors, and interfaces.

User or endpoint computing devices (e.g., 105, 110, 115, 120, 125, 145, 150, etc.) can include traditional and mobile computing devices, including personal computers, laptop computers, tablet computers, smartphones, personal digital assistants, feature phones, handheld video game consoles, desktop computers, internet-enabled televisions, and other devices designed to interface with human users and capable of communicating with other devices over one or more networks (e.g., 140). Attributes of user computing devices, and computing device generally, can vary widely from device to device, including the respective operating systems and collections of software programs loaded, installed, executed, operated, or otherwise accessible to each device. For instance, computing devices can run, execute, have installed, or otherwise include various sets of programs, including various combinations of operating systems, applications, plug-ins, applets, virtual machines, machine images, drivers, executable files, and other software-based programs capable of being run, executed, or otherwise used by the respective devices.

Some computing devices (e.g., 105, 110, 115, 120, 125, 145, 150, etc.) can further include at least one graphical display device and user interfaces allowing a user to view and interact with graphical user interfaces of applications and other programs provided in system 100, including user interfaces and graphical representations of programs interacting with plan models and plan-model-related tools and service provided, for example, by a plan model system 105. Moreover, while user computing devices may be described in terms of being used by one user, this disclosure contemplates that many users may use one computer or that one user may use multiple computers.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

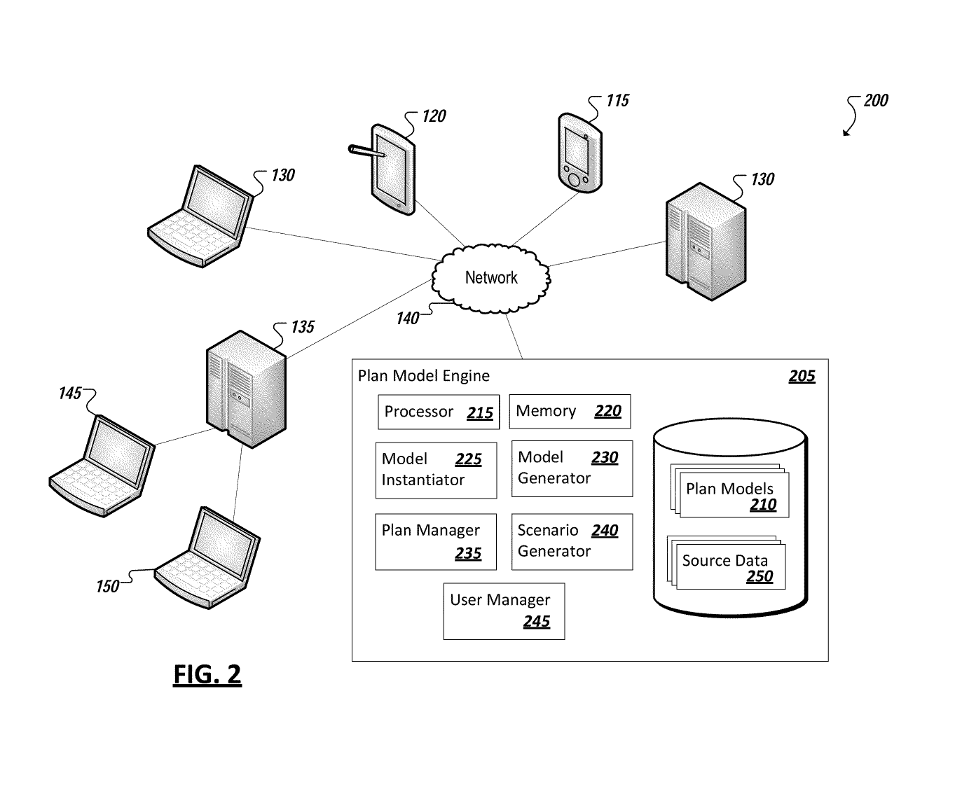

Turning to FIG. 2, a simplified block diagram is shown of an example system 200 including an example plan model engine 205. In some instances, plan model engine 205 can be hosted by a plan model system, such as the plan model system 105 described in the example of FIG. 1. In other examples, instances of a plan model engine 205 (including multiple distinct instances) can be hosted on enterprise computing platforms and other computing environments accessing and otherwise making use of plan models (e.g., 210). A plan model engine 205 can host, serve, maintain, access, or otherwise provide a set of plan models 210 used to model potential business outcomes of a particular organization or plurality of organizations. A plan model engine 205 can additionally include functionality for using, building, and editing plan models 210. Moreover, the example system 200 of FIG. 2 can further include one or more additional computing devices, systems, and software-based tools (e.g., 115, 120, 125, 130, 135, 145, 150) communicating with plan model engine 205, for instance, over one or more networks (e.g., 140).

In one example implementation, a plan model engine 205 can include one or more processors (e.g., 215) and memory elements (e.g., 220), as well as one or more software- and/or hardware-implemented components and tools embodying functionality of the plan model engine 205. In some examples, a plan model engine 205 can include, for instance, such components and functionality as a model instantiator 225, model generator 230, plan manger 235, scenario generator 240, and user manager 245, among potentially other components, modules, and functionality, including combinations of functionality and tools described herein. In addition, in some implementations, a plan model engine can include plan models 210 either hosted local to the plan model engine 205 or accessed from remote plan model servers or other data stores. Functionality of plan model engine 205 can access, utilize, and consume plan models of the plan model engine 205 as well as potentially plan models of other plan model systems or plan model engines (e.g., an instance of a plan model system belonging to another enterprise distinct from the enterprise or host of plan model engine 205), among other examples.

In some implementations, an example model instantiator 225 can include functionality for identifying and accessing plan models 210. For instance, a model instantiator 225 can be used, for instance, in connection with use of a particular plan-model-related application, one or more plan models relevant to one or more tasks performed using the application, etc. In some implementations, a model instantiator can also identify instances where a plan model is to be generated, edited, or otherwise modified. An example model generator 230 can be included possessing functionality for creating or editing plan models. In some instances, a plan model can be generated by instantiating an instance of a preexisting plan model, plan model template (or class), among other examples. Further, in some implementations, user interfaces and controls can be provided in connection with an example model generator 230 allowing human or automated users to input data to populate and be used in an instantiation of a plan model. In some instances, source data (e.g., 250) can also be collected, requested, retrieved, or otherwise accessed to populate attribute fields, build logic of the plan model, and be otherwise used (e.g., by model generator 230) to generate an instantiation of a particular plan model for addition to the set of plan models 210.

Particular instances of a plan model or a particular set of attribute values of a particular plan model can be adopted by an organization as a model of a current working plan, goal, assumption, or approach to be considered by the organization both in its analysis of other business scenarios (e.g., as modeled using plan models 205) as well as drive the real world behavior and decision-making of the organization. Various versions of one or more of the plan models 210 as well as the set of plan models themselves 210 can be tracked and managed using an example plan manager 235. For instance, a plan manager 235 can manage status of plan models 210, including modeled scenarios generated based on plan models. For example, a particular modeled scenario can be designated as a current working model, adopted business plan, etc. of an organization, and serve as a guide to the organization's decision makers and employees. Accordingly, the plan manager 235 can operate, in some instances, in connection with an example scenario generator 240 for use in connection with plan models 210. A scenario generator 240 can include functionality for generating hypothetical business scenarios based on one or more plan models. Such scenarios can include modeled scenarios based on particular or varying input drivers (e.g., modeling real world business-related inputs affecting a particular business goal or outcome), as well as based on particular goals (e.g., modeling hypothetical conditions that could result in a particular outcome). Additionally, some implementations of scenario generator 240 can further include functionality adapted to provide guidance to users in connection with the generation or modification of a particular scenario or comparisons of generated scenarios. Further, implementations of a scenario generator 240 can additionally include functionality for comparing generated scenarios, for instance, to determine whether a particular scenario is superior to another. In instances where a user determines that a particular modeled scenario is superior to other scenarios, including scenarios previously designated as current or adopted working models, the particular scenario can be flagged, saved, promoted, or otherwise specially designated, for instance, as a working or adopted scenario of the organization relating to particular goals of the organization, among other examples.

As noted above, in some instances, a particular plan model in a set of plan models 210 can model business outcomes relating to a particular business unit, department, domain, or sub-organization of an organization. Accordingly, some plan models may better relate to or be understandable to particular subsets of users and decision-makers within an organization. Indeed, one or more networks of plan models in plan models 210 can be provided, with each department, business unit, etc. of an organization having associated plan models in the network relevant to the particular entities, outcomes, work, and goals of that sub-organization. With each sub-organization utilizing, controlling, and accessing its own related plan models, collaborative decision-making and scenario-planning can be accomplished across an organization as the network of plan models models interplay and interconnectedness of various goals and outcomes of the various sub-organizations. Indeed, in some implementations, interactions with particular plan models 210 can be at least partially restricted, limited, or otherwise organized so that users utilizing and controlling modeling using particular plan models are associated with or expert in those sub-organization to which the particular plan models are related. In such implementations, an example plan model engine 205 can further include such modules as a user manager 245 that can manage users' roles, identities, and attributes as well as the users' respective permissions, access, and associations to one or more respective plan models, among other examples.

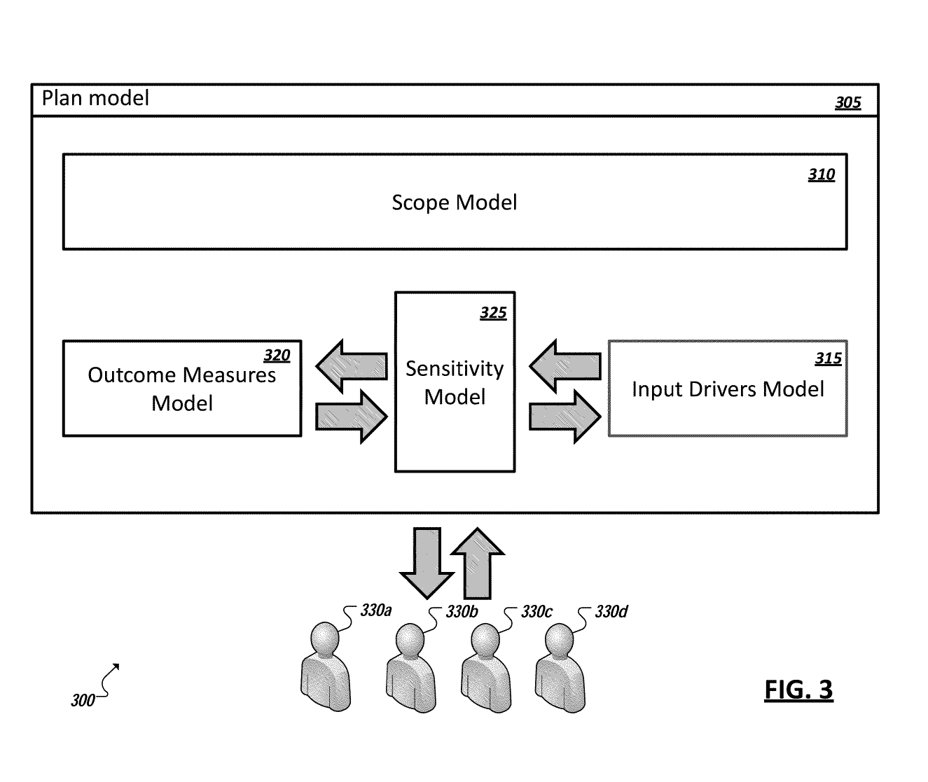

Turning to the example of FIG. 3, a simplified representation 300a is shown representing principles of an example, software-implemented plan model 305. A plurality of instances of plan model 305 can be developed, each instance of plan model 305 modeling a respective business outcome of an organization (or group of organizations), including business outcomes relating to administrative, educational, charity, commercial, industrial, logistic, and other for profit and not-for-profit activities of the organization. In one example implementation, a plan model can include a scope model 310, an input drivers model 315, a sensitivity model 320, and outcome measures model 320. Additional models can be included in or linked to by a respective plan model, such as entity models, member models, and hierarchy models. Additionally, in some implementations, plan models can each include a process model for use in managing planning activities involving the plan model as well as coordinating planning activities between multiple plan models. Further, one or more designated users, user roles, or users within particular sub-organization (collectively users 330a-d) can interact with and use the plan model, for instance, in connection with planning activities within one or more organizations.

Generally, a scope model 310 can identify and model the specific domain within an organization on which the particular instance of the plan model 305 operates and is associated with. Domains can be relatively broad or narrow and capture certain segments of a particular organization. The scope model 310 can further enable certain domain-specific planning processes and logic relevant to the corresponding domain within the organization. Input drivers model 315 can represent one or more input drivers specifying key variables influencing outcome measures modeled by the particular domain-specific instance of the plan model 305. Accordingly, outcome measures model 320 can model and represent the outcome measures that the particular instance of the plan model will state, predict or attempt to achieve in its modeling of a particular business outcome(s) which can also be expressed as one or more of the outcome measures modeled in outcome measures model 320. A sensitivity model 315 can define the dependencies, relationships, processes, formulas, and other logic used to derive values of various outcome measures from values of input drivers of the plan model 305. Such dependencies, relationships, processes, formulas, and other logic (collectively dependencies) can be domain-specific as well as define how values of intermediate outcome measures or input drivers can be derived from other input drivers or outcome measure values, among other examples.

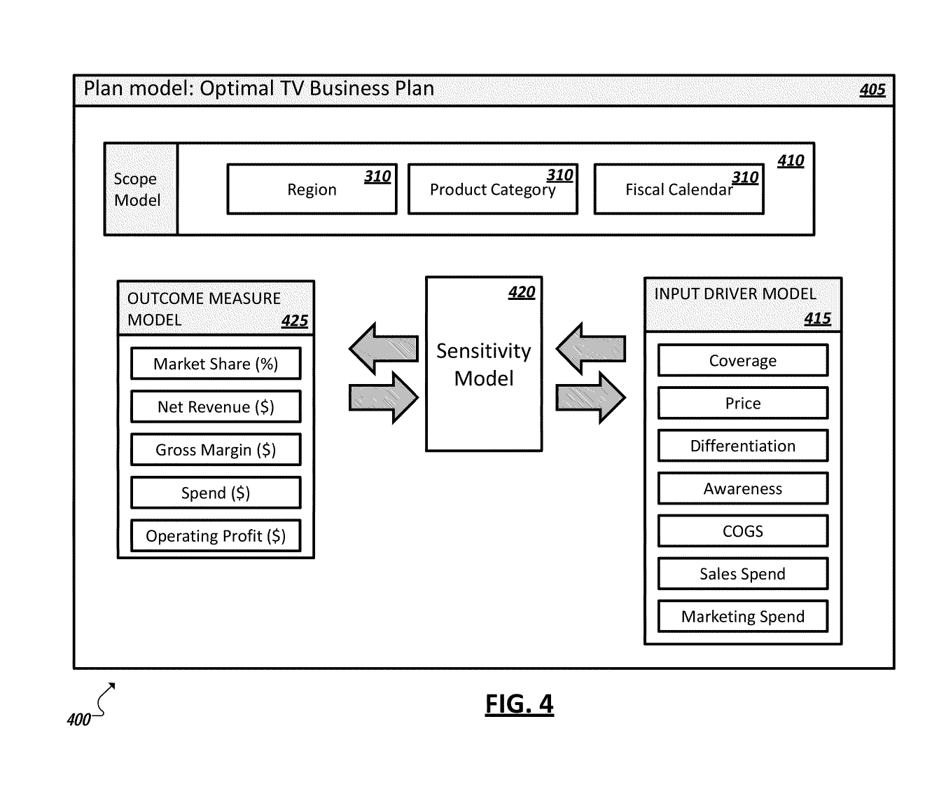

Turning to the example of FIG. 4, a simplified schematic block diagram 400 is shown of a particular example instance of a plan model 405. In this example, the plan model 405 is an optimal television business plan model modeling outcomes for a particular product category of a business (e.g., a business selling televisions). As in the example of FIG. 3, example plan model instance 405 can include a scope model 410, input drivers model 415, sensitivity model 420, and outcome measures model 425. Scope model 410 defines a domain to which the modeled outcomes of plan model 405 apply. For instance, scope model 410 can model a domain encompassing a particular product category (i.e., TVs), within one or more geographic regions (or market regions), and within a particular period of time (e.g., a fiscal quarter, year, five year span, etc.). Accordingly, scope model 410 can define the domain according to one or more business entities, such as in this example, regions, product categories, and fiscal calendar. Moreover, in this implementation, scope model 410 can include entity models 430, 435, 440 corresponding to the relevant business entities used to define the domain in the scope model 410.

A plan model's domain, as defined in its scope model (e.g., 410) can drive other models (e.g., 415, 420, 425) of the plan model as the inputs, outcomes, and relationships between outcomes and inputs (e.g., as defined in sensitivity model 420) can be highly domain-specific and tied back to the particular business entities used to define the modeled domain. For instance, in the example input drivers model 415 can include such input drivers, or variables, pertaining to a television product category and product market region for televisions, including input drivers such as channel coverage, price, product differentiation, consumer awareness, cost of goods sold (COGS) or inventory cost, sales spend, marketing spend, etc. Similarly, outcome measures relevant to the outcome, or goal, modeled for the defined domain can be defined in outcome measures model 425, such as market share percentage, net revenue, gross margin, total spend, operating profit, etc.

Some plan models will model outcomes of domains that result in sets of input drivers and outcome measures quite different from the input drivers and outcome measures of the particular example of FIG. 4. However, other plan models can also be developed for different domains (e.g., a different market region, different product, products of a different organization, etc.) that include input drivers and outcome measures similar to those of the optimal television business plan model 405. The dependencies of the respective outcome measures on the respective input measures of a particular domain, however, can fluctuate considerably between domains. For instance, sensitivity of a market share outcome measure to particular input drivers such as price or product differentiation can be quite different in two different markets, including different product markets and market regions. Accordingly, sensitivity model 420 can define domain-specific dependencies between input drivers and outcome measures for a plan model of a particular domain, representing the sensitivities of the outcome measures to the respective input drivers upon which the value of the outcome measure is dependent.

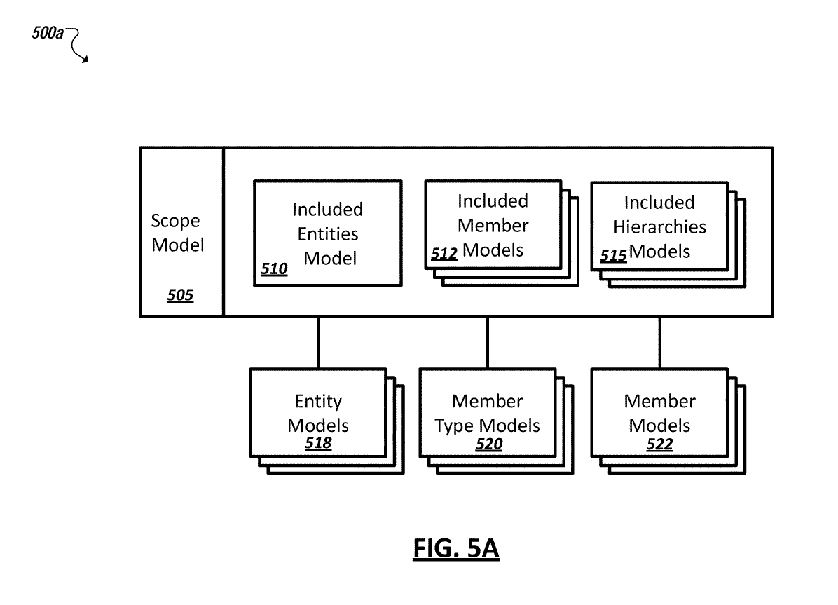

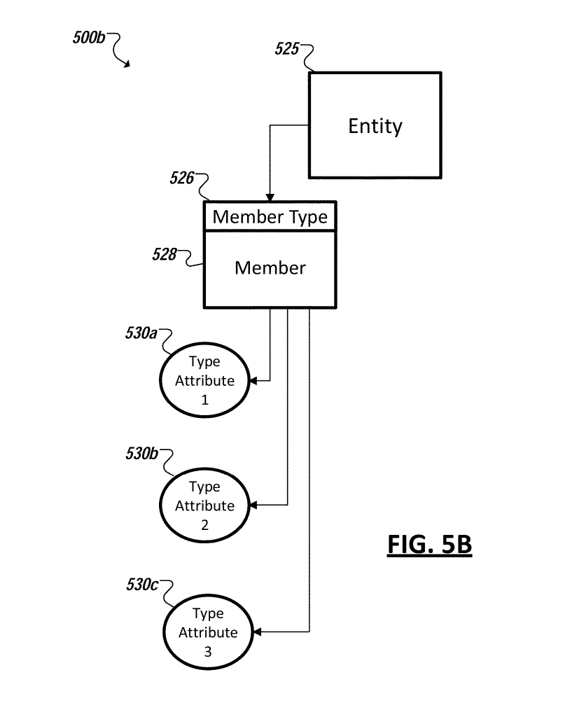

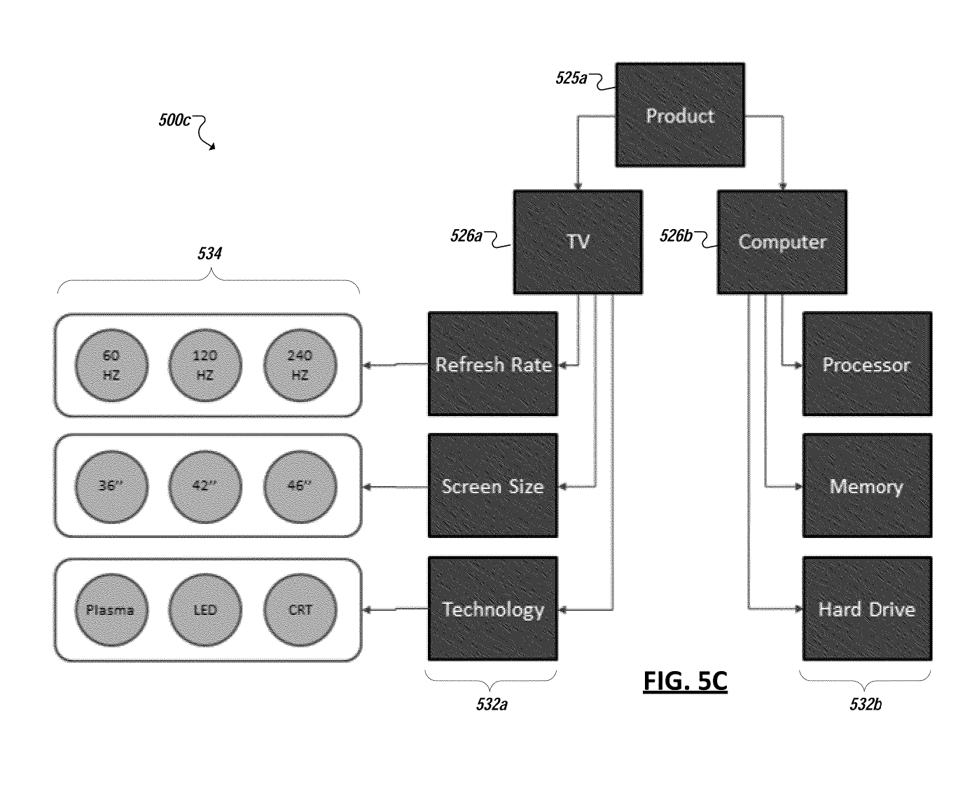

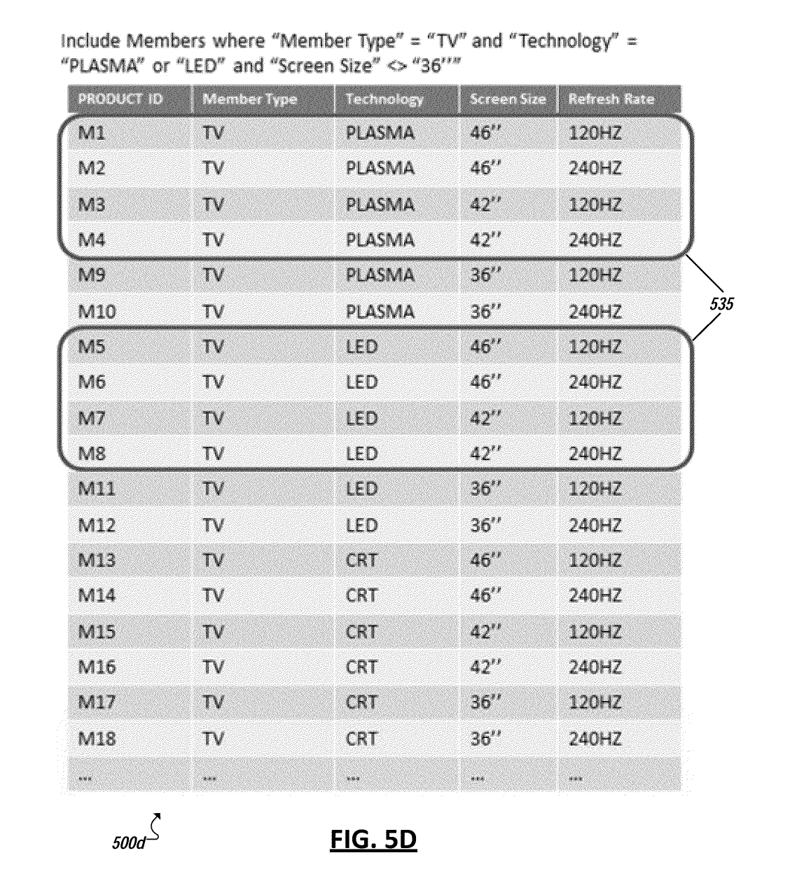

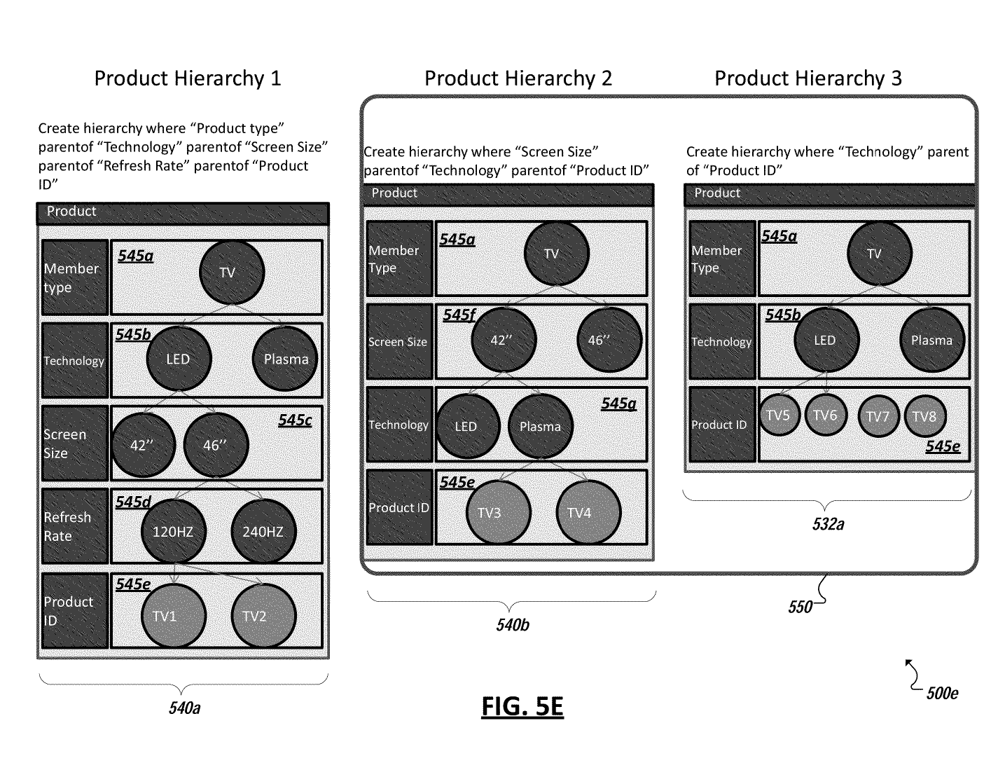

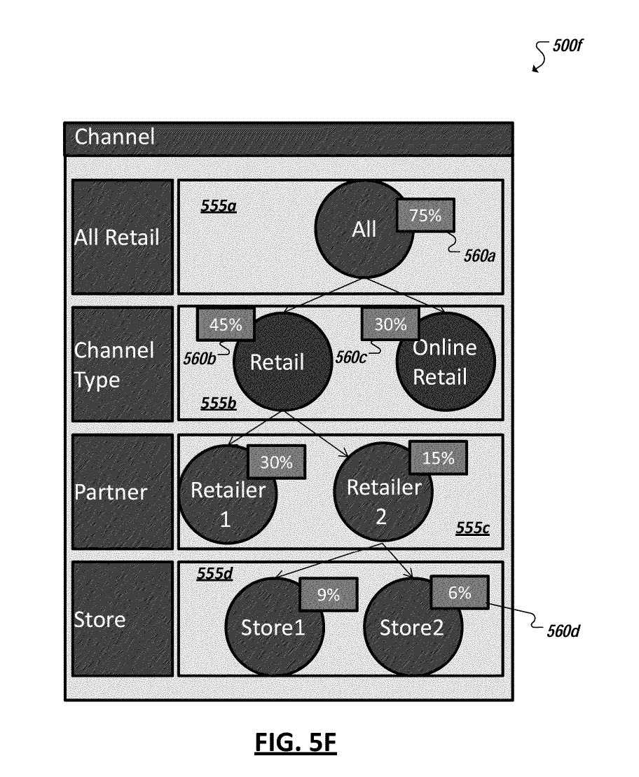

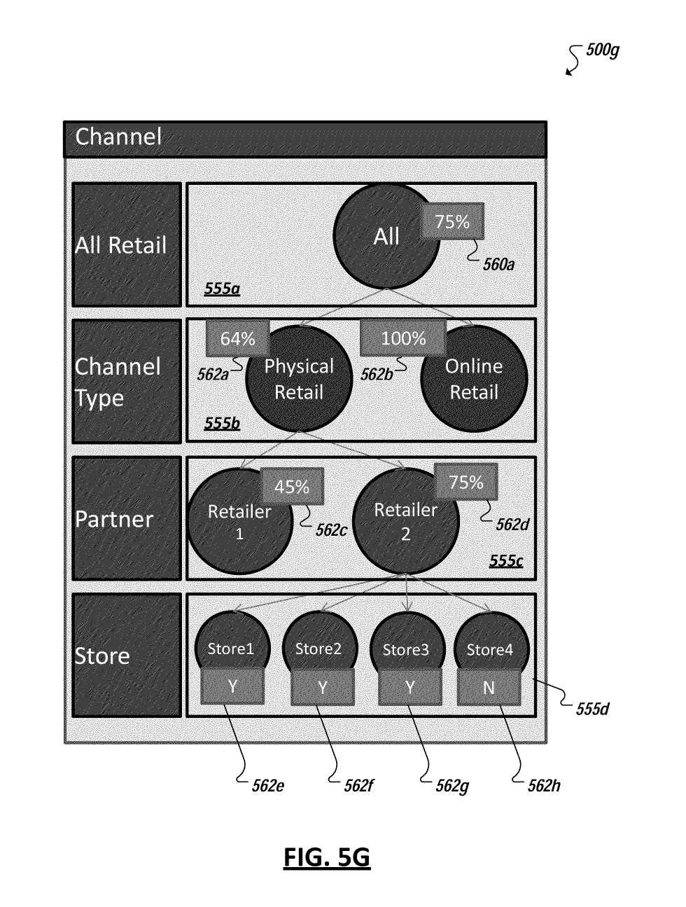

Turning to FIG. 5A, a simplified block diagram 500a is shown illustrating an example scope model structure. For instance, instances of a scope model 505 included in plan models can include an included entities model 510, one or more included members models 512, and one or more included hierarchies models 515 corresponding to those business entities designated as defining the particular domain of the scope model instance 505. The included entities model 510 and included member models 512 can reference or link to one or more entity models 518, member type models 520, and member models 522 maintained in connection with a plan model system. As noted above and in other example discussed herein, business entities can include such entities as regions, organizations, persons, products, product categories, market regions, market segments, channels, calendar periods, time, locations, customers, suppliers, factories, and so on. The entities included in the domain can be defined in included entities model 510. A particular business entity can have constituent subcategories of business entities, or member types, and particular members of these entity member types can be included in the particular domain to which a plan model applies. Accordingly, in some examples, each entity designated in included entities model can have a corresponding set of designated members of the respective entity designated in a respective included member model 512. Additionally, for each designated entity, a set of included hierarchies (or included different possible hierarchical representations of the included members of an entity) can be designated in included hierarchies models 515, each entity having its own included hierarchy model 515. In other implementations, the sets of included members and/or included hierarchies can be defined in a single included member model for the scope model 505 or a single included hierarchies model for the scope model 505 (i.e., rather than distinct included member models 512 and included hierarchies models 515 for each individual entity designated in an included entities model 510), among other examples.

Further, a scope model 505 can reference (e.g., through included entities model 510) corresponding entity models 518 of the designated included entities of the domain modeled by the scope model. Entity models 518 can model a particular entity as well as the member types of the entity, hierarchies of the entity, and other attributes and information pertaining to the individual entity. Member type models 520 can also be referenced through the scope model, each member type model 520 modeling a particular type of the business entity as well as defining relevant attributes of that member type (or member type attributes). Further, member models 522 can be referenced, corresponding to the included member models 512, each member model 522 defining the individual members within a particular modeled domain. Each member can be of a particular one of the member type models 520. In some implementations, included member models 512 can be defined for each entity of the domain and included as sub-models of the entity models 518. Relationships between entities, member types, members (or groups (or “sets”) of members), and particular member type attributes can be hierarchical and, in some instances, be organized in multi-dimensional hierarchies that allow members, member groups, and member type attributes to organized in multiple different alternate hierarchies. Such hierarchical organizations can be defined, in some instances, through included hierarchies models 515.

Turning to FIG. 5B, an example block diagram 500b is shown of a simplified hierarchy of a business entity as can be captured through one or more models of the corresponding scope model and/or entity model of a corresponding included business entity including corresponding member type models, member models, included hierarchies models, etc. For instance, in the particular example of FIG. 5B, a member type can be one of a plurality of member types of an entity and each member type (e.g., 526) can include one or more instances, or members (e.g., 528), of that particular member type (e.g., 526). The member type (e.g., 526) can define a set of member type attributes (e.g., 530a-c) relevant to members of that type and that can define members of that type. Indeed, each member (and member model) of a particular member type can inherit the member type attributes of the corresponding member type. To illustrate, turning to FIG. 5C, an example entity 525a is illustrated corresponding to a product business entity. Within the global marketplace a wide variety of different products may exist from smartphones, printers, and digital video recorders to cardboard packaging, breakfast cereal, and tissue papers, among scores of other examples. Further, in the example of product business entities, various products may have relevance to different organizations and different goals within the same organization. Accordingly, plan models can include product business entities within their domains for different reasons in modeling particular outcomes, including domains corresponding to particular products of a particular business unit of an organization, corresponding to competitor products, corresponding to marketing budgets, inventory, etc.

In the particular example 500c of FIG. 5C, a scope model can define a particular domain to which a particular plan model applies by defining two particular member types within the product business entity 525a, in this example, a televisions member type (526a) and computer member type (526b). Each of the member types 526a, 526b can respectively define a set of member-type attributes (e.g., 532a, 532b) describing features and details generally relevant to members of that type. For example, a television member type 526a can include member type attributes such as the refresh rate, screen size, and technology (e.g., LED, LCD, plasma, etc.) of a particular television (i.e., member of the television member type), including other potential television-related attributes. Similarly, a computer member type, while a member type of the same business entity (e.g., Product), can have a different set of attributes corresponding to features and specifications of computers, such as processor type, processor speed, memory, hard drive, etc.

Each member of a member type can be defined, at least in part, according to attribute values defined for the member. For instance, a variety of different attribute values (e.g., 534) may exist among a set of members. For example, a first television member considered in the domain may be a 120 Hz 42″ LCD television, while a second television member in the domain is a 240 Hz 46″ plasma model. In some instances, multiple members in a member type can share one or more attribute values. Shared member type attributes can serve as the basis for member groups. For instance, a group of members of the example television member type of FIG. 5C can be defined based on screen size, with a group of televisions being defined for 36″ televisions, 42″ televisions, 46″ televisions, and so on.

Turning to the example chart 500d of FIG. 5D, a simplified set of members of a particular member type (e.g., televisions) is represented. In addition to defining a domain according to the business entities and member types to which a particular plan model applies, a scope model (e.g., through an included members model) can further define the domain by the individual members included in the domain. For instance, a set of member television models is listed in chart 500d. A particular domain, however, may only be interested in a particular subset of the set of members available. For instance, a set of included members 535 can be defined that pertains to a set of televisions of interest within the domain, such as televisions made in a certain year, televisions manufactured by a particular plant or vendor of an organization, televisions sold in a particular store or region of an organization, etc.

Further, as can be seen in the example of FIG. 5D, members of an entity (or member type) can share some common attributes and attribute values. On the basis of shared attribute values, members can be grouped or sorted based on the shared attribute value. For instance, included member televisions “M5”-“M8” can be included in an LED TV member group while member televisions “M1-M4” are included in a plasma TV member group. Individual members can belong to multiple member groups. For instance, in the example of FIG. 5D, a member “M1” can belong both to the plasma TV member group, as well as a 46″ screen size member group (along with members “M2”, “M5”, and “M6”), 120 Hz refresh rate member group (along with members “M3”, “M5”, and “M7”), as well as other member groups. Indeed, in some implementations, member groups of an entity can span multiple member types. For instance, in one example, member types “TV” and “Computer” can share an attribute “price” and members from both member type groups can populate member groups organized according to particular defined price ranges, among other examples involving other business entities, member types, and member attributes.

As noted above, entities and their respective members can be used to define the domain of a plan model. In some instances, a scope model can include an included entities model specifying the set of entities on which the plan model operates. Further, business entities can be hierarchical in nature. Further, multiple alternate hierarchies can exist for a business entity and serve to represent members of the entity at varying levels of aggregation. In some implementations, these levels of aggregation can also be based on or formed from the varying combinations of member groups that can be defined within a business entity. Turning to the example of FIG. 5E, a set 500e of three block diagrams are shown representing example available hierarchies 540a-c of a particular business entity. More specifically, in the particular example of FIG. 5E, three available hierarchies 540a-c are shown of a product business entity included in a domain also specified by members of member type “television,” similar to the example television member type in the illustrative examples of FIGS. 5C and 5D. In a first (540a) of the available hierarchies 540a-c, television technology type is designated as the first level of aggregation within the hierarchy 540a. Further, in the example hierarchy 540a screen size is designated as a child to technology type and refresh rate as a child of screen size. Based on this designated hierarchy 540a various groupings of members can be identified and aggregated at the levels of aggregation 545a-e defined by the hierarchy 540a. For instance, a highest level of aggregation 545a in hierarchy 540a can include all members of member type television. At a second highest level of aggregation 545b in hierarchy 540a, two distinct member groups can be identified for two member groups defined by their respective shared technology types (e.g., a LED member group and plasma member group). Further at the next level of aggregation 545c, respective sub-member groups of the LED and plasma member groups can be defined according to the screen sizes of constituent members included in each of the LED and plasma member groups. For instance, 42″ LED television member group can be included or defined at level of aggregation 545. Further, still lower levels of aggregations (e.g., 545d, 545e) can be provided based on the defined hierarchy 540a. Indeed, a lowest level of aggregation 545e can be provided representing the individual (i.e., ungrouped) members themselves (e.g., as identified by a member ID attribute of the member type, such as “Product ID”).

In addition to hierarchy 540a of a product business entity of an example plan model, further hierarchies 540b and 540c can be provided organizing the product business entity according to other member attributes and defining further potential member groups and levels of aggregation. For instance, a second hierarchy 540b can provide for a screen size attribute of a television member type as the parent to a television technology type which can, in turn, serve as the parent to a product ID attribute, thereby defining four levels of aggregation 545a, f-h. In the example of hierarchy 540c, member type is a parent of the television technology attribute which is a parent of the product ID attribute, thereby defining a hierarchy providing levels of aggregation 545a, b, e.

As shown in the example of FIG. 5E, included members and member groups of a particular business entity can be organized or arranged into a plurality of different hierarchies allowing the members to modeled or analyzed at a variety of levels of aggregation. In some implementations, the domain defined by the scope model can specify (e.g., through an included hierarchies model) a particular subset of the available hierarchies that are relevant to the modeling of goals or outcomes of the domain. For instance, a hierarchies model (e.g., 520a-c) can specify only those particular hierarchies in which included members and member groups can be arranged into or that have otherwise been designated (directly or indirectly) for inclusion in the domain. Indeed, in some instances, through designation of a set of included entities, a set of included entity members, and a set of included hierarchies a plan model domain can be specified and distinct domain-specific planning can be enabled through the corresponding plan model. Specification of included entities, members, and hierarchies can be completed manually (e.g., via human user input and user-defined rules and settings), as well as via computer-controlled inputs, logic, and systems. Further, a domain can be defined and modified according to the specification of particular entities, members, and hierarchies as well as through additions, substitutions, deletions, and other changes to the respective sets of included entities, members, and hierarchies.

In addition to enabling domain-specific planning, a plan model can further allow management and planning at varying levels of aggregation within a domain-specific context. For instance, turning to the example of FIG. 5F, a simplified block diagram 500f is shown representing how input drivers and outcome measures of a plan model can be viewed, analyzed, and manipulated at any level of aggregation provided through the included hierarchies of the plan model's domain. For simplicity, the example of FIG. 5F illustrates how a single value can be viewed and/or manipulated across different levels of aggregation (e.g., 555a-d). In this particular example, the value pertains to channel coverage for one or more products and can in some instances be an input driver or in other cases an outcome measure (or even both an outcome measure for a first plan model and input driver for a second plan model linked to the first plan model through the use of one or more outcomes of the first plan model for some of its inputs, among other examples).

In the example of an input driver for a particular domain, a single input driver value for aggregate channel coverage of the products included in this particular domain can be 75%. This 75% value (at 560a) can be broken down, or disaggregated, either automatically via logic or rules defined in the plan model (e.g., in a sensitivity model of the plan model instance) or manually through user- or system-provided values and/or rules to show what portion of this 75% channel coverage value is attributable to either one of the two member groups, “Retail” and “Online Retail,” at the second level of aggregation 555b. In this example, of the 75% channel coverage, 45% of the channel coverage (at 560b) can be modeled as from Retail channel types and the remaining 30% (at 560c) from Online Retail channel types. The 75% value (at 560a) can be further analyzed at other levels of aggregation, included lower levels of aggregation, such as at a level of aggregation grouped by channel type, channel partner, and store identifier, as at example level of aggregation 555d. For instance, of the 75% channel coverage modeled, 6% (at 560d) can be attributable to a first particular store of a particular channel partner Retailer B of a Retail channel type. Further, at each level of aggregation, values for the input driver can viewed and manipulated. For instance, a user can manipulate the value 560c upward or downward, thereby also potentially affecting values across the hierarchy, such as values 560b, 560d, etc.

In addition to allowing different views of input driver (or outcome measure) values at varying levels of aggregation, values can be disaggregated in different ways within the same plan model. For instance, in the example of FIG. 5G, rather than disaggregating the value 560a into the portions of the 75% attributable to each of the other, lower-level member groupings (e.g., physical retain vs. online retail; Retailer 1 vs. Retailer 2, etc.), the respective channel coverage of each member group at each level of aggregation can also (or instead) be enabled and represented using the included hierarchies of the scope model. For instance, an organization may have 100% coverage (e.g., at 562b) in the available online retail channels (e.g., as defined in an included members model of the retail channel entity), but only 64% (e.g., at 562a) of the available physical retail channels covered. Similarly, the organization may have 45% (at 562c) of the stores of Retailer 1 covered and 75% (at 562d) of Retailer 2's stores covered. For instance, Retailer 2 may have four available stores, with values 562e-h indicating whether each member store is covered or not, thereby representing the values at the lowest, most detailed level of aggregation, among many other examples. Further, while viewing and manipulating input drivers across multiple levels of aggregation provided through a plan model has been discussed in connection with some of the examples above, similar concepts apply to the outcome measures, with a single outcome measure value capable of being disaggregated, viewed, and manipulated at multiple levels of aggregation, as provided by hierarchies of the respective plan model.

In addition, to allowing analysis and management of input driver and/or outcome measure values at multiple levels of aggregation within a single hierarchy of a single business entity, plan models with multiple business entities (e.g., 565a-c) in its domain can in some cases provide for management and manipulation of input drivers and outcome measures at multiple different levels of aggregation across the multiple different business entities and hierarchies defining the domain. For instance, turning to the examples of FIGS. 5H-5G, simplified block diagrams 500h-i illustrate how a single input driver or outcome measure can apply to and intersect multiple business entities, members, and member attributes. Accordingly, input driver and/or outcome measure values can be managed at various available levels of aggregation defined by the respective hierarchies of the business entities. To illustrate, an example market share percentage outcome measure can be expressed in terms of multiple business entities, in this example, a Product business entity 565a, Region business entity 565b, and a Fiscal Calendar business entity 565c. Further, within each business entity potential multiple different hierarchies can be provided to arrange members and member groups of the business entity as well as manage values of the outcome measures (and input drivers). For instance, a first hierarchy 570a of the Product business entity 565a can be organized with a descending hierarchy of member attributes Screen Size→Technology→Member ID defining levels of aggregation 575a, 575b, 575c. Similarly, a particular one (e.g., 570b) of the available hierarchies of the Region business entity 565b can be utilized with a hierarchy Country→State and levels of aggregation 575d, 575e, as well with a hierarchy 570c of the Fiscal Calendar business entity providing levels of aggregation 575f-575i.

Against the backdrop of this particular example, input drivers and outcome measures can be manipulated and managed at multiple combinations of different levels of aggregation across the three hierarchies 570a-c of the three business entities 565a-c of the present example. For instance, in the example of FIG. 5H, a market share outcome measure can be viewed and managed at a level of aggregation 575a for the Product business entity 565a, at a level of aggregation 575d for the Region business entity 565b, and at a level of aggregation 575g for the Fiscal Calendar business entity 565c. In the other example of FIG. 5I, outcome measures can be instead managed at different levels of aggregation. For instance, market share values could be analyzed and controlled at a lower level of aggregation 575b for the Product business entity 565a, at the same level of aggregation 575d for the Region business entity 565b, and a higher level of aggregation 575f for the Fiscal Calendar business entity 565c. As should be appreciated, a wide variety of different, alternative combinations of levels of aggregations can be employed in the management of the market share outcome measure (among other input drivers and outcome measures), including other levels of aggregation defined and provided through other alternative hierarchies available through the business entities 5605a-c of the example domain of FIGS. 5H-I, as well as any other domain modeled by other plan models developed using these principles. In this way, users of the plan model can have flexible and varied control of information and analytics pertaining to goals and outcomes within a particular domain as well as across multiple different domains.

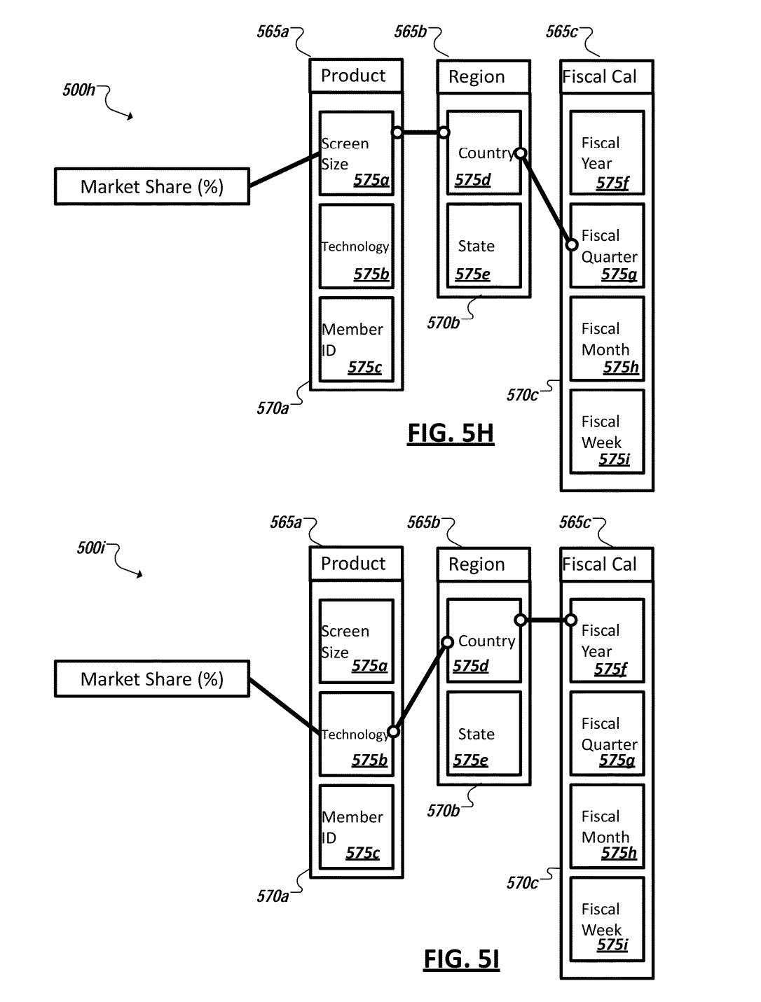

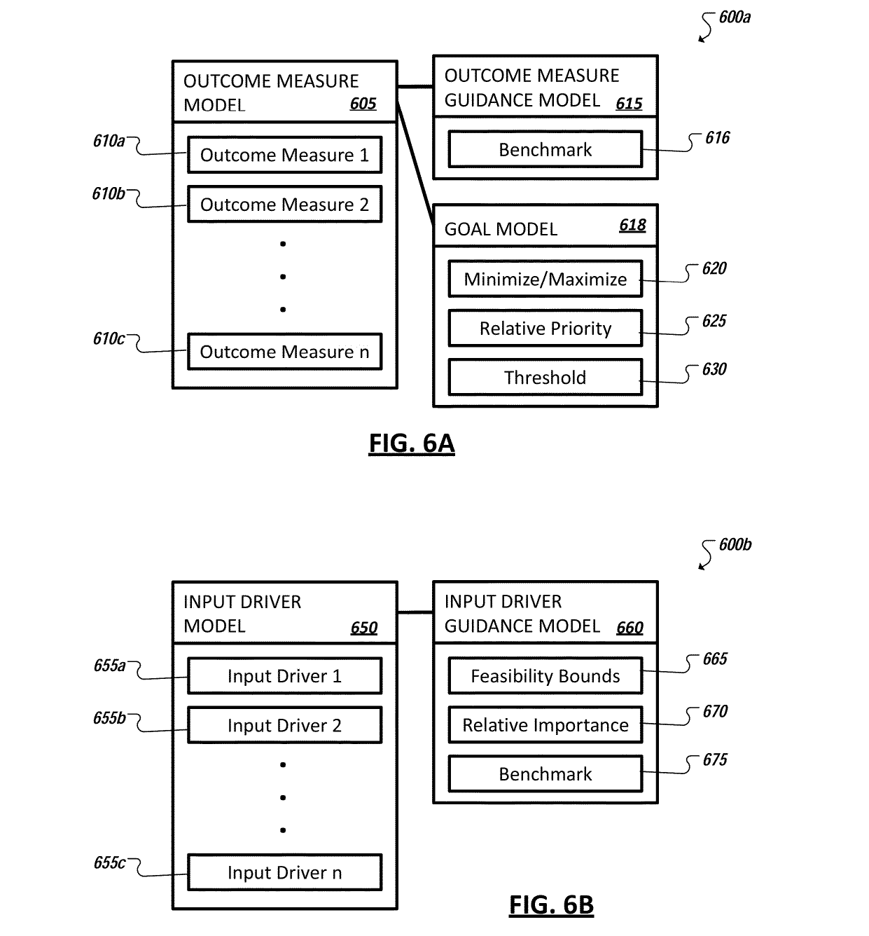

Turning to FIGS. 6A and 6B, in addition to defining the domain of a particular plan model enabling distinct domain-specific modeling and input and outcome management, a plan model can additionally define the input drivers and outcome measures pertinent to the domain together with parameters and guides for the input driver and outcome measure values. Such parameters and guides can also be used to provide domain-specific guidance to users in their management, manipulation, analysis, and use of domain planning processes, goals, and outcomes modeled through plan model instances.

Turning to the simplified block diagram 600a of FIG. 6A, outcome measures of a particular plan model can themselves be modeled in instances of an outcome measures model 605. An outcome measures model 605 can define the outcome measures (e.g., 610a-c) pertinent to the domain-specific outcomes and goals modeled by the plan model. Each defined outcome measure can represents an outcome that the plan model will state, predict or attempt to achieve. Further, the outcome measure model 605 can define, for each outcome measure, such attributes as the name, type, unit of measure, etc. of the respective outcome measure. Additionally, a goal model 618 can be defined for the provided in the plan model to define one or more goals of the plan model based on the outcomes modeled by the outcome measure model 605. Further, in connection with the defined outcome measures 610a-c, an instance of an outcome measure guidance model 615 can further be provided in connection with the plan model.

The guidance model 615 can be used to model limits or targets of values of the respective outcome measures 610a-c. For instance, a guidance model can provide direction or limitations on values of outcome measures, according to one or more guidance rules defined in the outcome measure guidance model 615. For instance, a benchmark model 616 can be included in outcome measure guidance model 615 defining guidance rules such as indicators or limits corresponding to a defined best-in-class, worst-in-class, median, market rank value, etc. Other guidance rules can be defined using other models included in outcome measure guidance model 615.

A goal model 618 can be included in some implementations of plan models and can be used to reference and guide outcome measure values of the plan model. For instance, a goal model 618 can define the goals set for a particular domain modeled by the plan model and can be used as a reference point for scenarios generated using the plan model. In one example implementation, a goal model 615 can define, when applicable, minimize/maximize guidance 620 for each outcome measure 610a-c, relative priority guidance 625 for the outcome measures 610a-c, and threshold guidance 630 for each outcome measure 610a-c, as well as target values for one or more outcome measures 610a-c of the plan model. Generally, minimum/maximum guidance 620 can specify, for each outcome measure 610a-c, if the objective of the outcome measure should be maximized or minimized in connection with the domain's goal. Relative priority guidance 625 can generally specify the priority between the outcome measures 610a-c in the event of conflicts between the outcome measures' other guidance values. Additionally, threshold guidance 630 can generally specify the bounds for each outcome measure's values, such as rules specifying that the value of a corresponding outcome measure not go below a value for a maximization objective (i.e., defined in minimum/maximum guidance 620), or not to go above a value for minimization objective (i.e., defined in minimum/maximum guidance 620), and so on.

Turning to FIG. 6B, input drivers of plan models can also be modeled, for instance, through instances of an input drivers model 650 included within a respective plan model. An input drivers model 650 can define the respective input drivers (e.g., 655a-c) pertinent to the plan model's domain and specifying the key variables that influence the outcome measures and domain-specific considerations to be managed by users of the plan model. Further, an input drivers model 650 can also define, for each input driver, such attributes as the name, type, unit of measure, etc. of the respective input driver. Generally, each input driver of a plan model, represent or model particular factors that can exist or decisions that can be made that involve the modeled domain. For instance, input drivers can model decisions that can be under the control of the domain or organization, decisions outside the control of the domain or related organization(s), factors beyond the control of entities internal or external to the domain (e.g., drivers based on environment or market factors), or any combination thereof.

As with outcome measures, input driver guidance models 660 can also be provided to model limits or targets of values of the respective input drivers 655a-c and serve to guide users in their management of input driver values and planning using the corresponding plan model. In some implementations, an input driver guidance model 660 can include feasibility bounds guidance 665 for each of the input drivers 655a-c, relative importance guidance 670 among the input drivers 655a-c, and benchmarking guidance 675 for each of the input drivers 655a-c. Generally speaking, feasibility bounds guidance 665 can model assumptions and constraints for values of a given input driver and provide warnings or enforce limits when input driver values are provided in violation of set feasibility bounds, for example. Relative importance guidance 670 can specify the relative impact of an input driver relative to the set of input drivers 655a-c, on one or more outcome measures of the plan model. Further, benchmarking guidance 675 can generally specify benchmarking details for provided or set values of each of the input drivers 655a-c, among other potential examples.

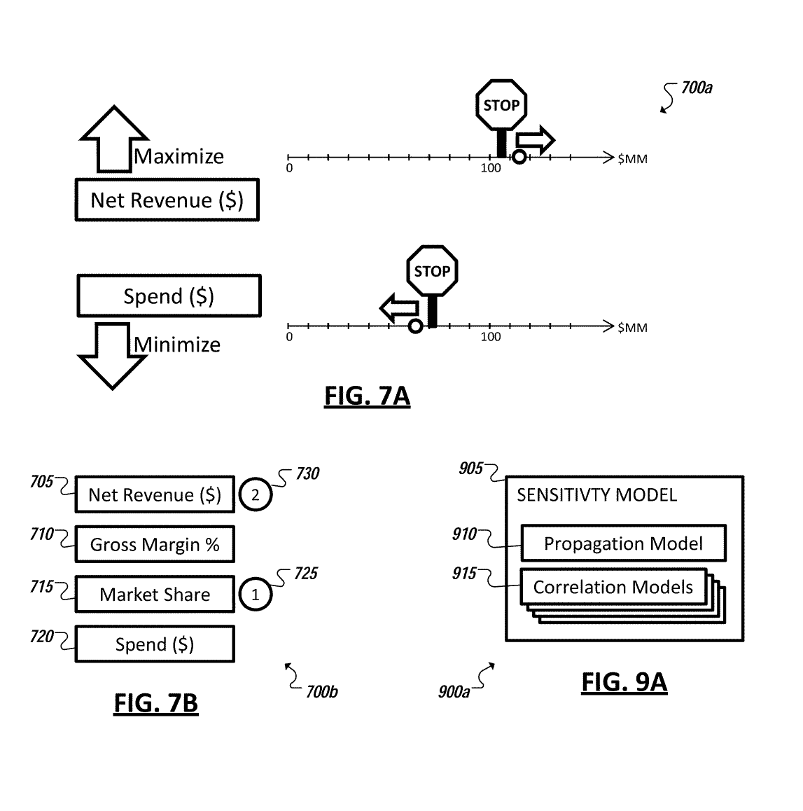

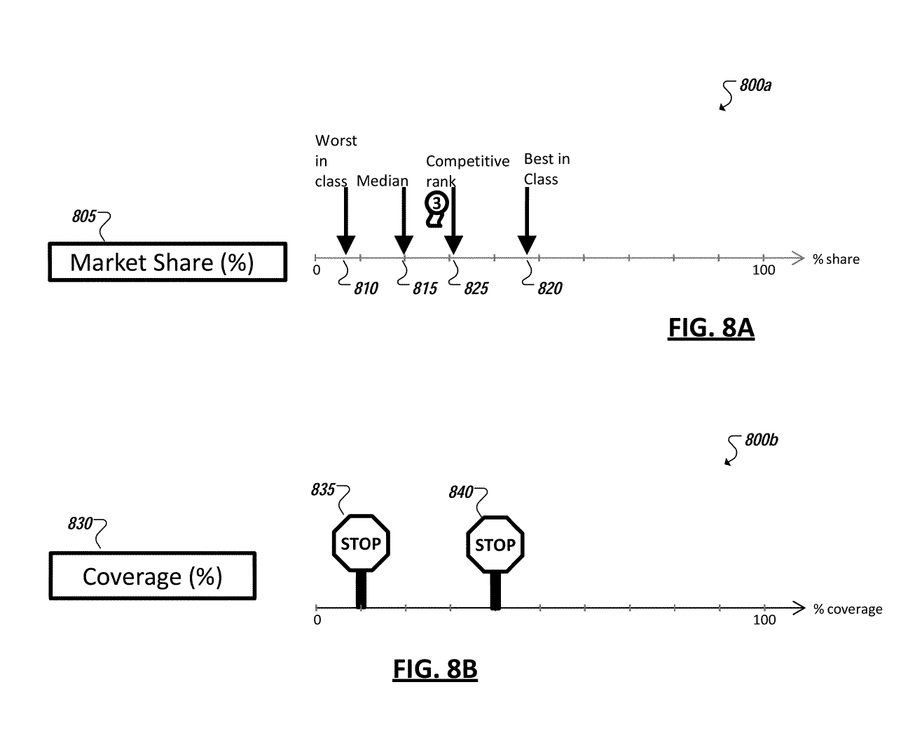

Continuing with the discussion of outcome measures, input drivers, and corresponding guidance models that can be applied to improve, guide, and constrain construction and selection of planning and goal scenarios, analyses, and other uses of a plan model, FIGS. 7A, 7B, 8A, and 8B are provided illustrating simplified block diagrams 700a-b, 800a-b representing examples presented to illustrate particular features of example guidance rules that can be defined in guidance models (e.g., 615, 660) or goal models (e.g., 618) employed in example plan models. For instance, turning to the example of FIG. 7A, minimize/maximize guidance is represented for two example outcome measures, Net Revenue and Spend, within a particular plan model. Within a particular domain, it can be a goal to maximize net revenue generated in the domain while minimizing total costs of the domain (e.g., to maximize profit). Accordingly, for this particular plan model, minimize/maximize guidance can be defined within a goal model of the particular plan model setting rules or guidelines for at least the Net Revenue and Spend outcome measures of the plan model that their values be respectively maximized or minimized when possible. Further, minimize/maximize guidance can further define threshold values for respective outcome measures, either ceilings or floors for the respective values of the corresponding outcome measures. For instance, in the example of FIG. 7A, minimize/maximize guidance for the Net Revenue outcome measure can be set guidance or rules to promote maximization of the Net Revenue outcome measure values and not allowing the value of Net Revenue to fall beneath a value of $105 MM, as an example.

In the simplified block diagram 700b of FIG. 7B, relative priority guidance for outcome measures of a plan model is represented. In some instances, set goals, rules, or guidance for different outcome measures in a plan model can conflict. For instance, as in the example of FIG. 7A, in some cases the minimization of costs can be in direct conflict with the maximization of net revenue. Relative priority guidance can provide rules for resolving conflicts between outcome measures and the respective guidance rules applied to them to define a hierarchy of tradeoffs that can be exercised in the establishing or calculating of outcome measures during the use of the plan model. For instance, in the example of FIG. 7B, relative priority guidance can be set (e.g., by a user or developer of the corresponding plan model) for one or more of the outcome measures 705, 710, 715, 720. For instance, a Market Share outcome measure 715 can be assigned priority position “1” (725) giving the values and goals of the Market Share outcome measure 715 priority over all the remaining outcome measures (e.g., 705, 710, 720) in the corresponding plan model. Further, the next highest priority (730) can be assigned for Net Revenue outcome measure 705, giving it priority over all other outcome measures (e.g., 710, 720) with lesser priorities defined in priority guidance. Further, some outcome measures (e.g., 710, 720) can be assigned no priority meaning that the system is free to resolve conflicts between unprioritized outcome measures (e.g., 710, 720) any way it deems fit. However, when conflicts arise between an outcome measure and another outcome measure of higher priority, the outcome measure with higher priority takes precedence. For example, minimize/maximize guidance for outcome measures Net Revenue 705 and Market Share 715 may dictate that values of the outcome measure 705, 715 be maximized. However, if maximization of the Net Revenue 705 value conflicts with realizing a potentially higher, or maximum value for Market Share 715, priority guidance can indicate or even resolve the conflict by treating maximization of Market Share 715 as a priority over maximizing Net Revenue, among other potential examples. Similar principles can be applied to relative importance rules (e.g., at 670) for input drivers.

Turning to the example of FIG. 8A, a simplified block diagram 800a is shown representing an example benchmarking guidance for a Market Share input driver of an example plan model. Similar principles can be applied in benchmarking guidance defined and applied for outcome measures (e.g., through benchmark model 616). Benchmarking guidance can designate various benchmark values for a corresponding input driver or outcome driver such as values that would make the value the best in class within a market, worst in class within the market, a certain rank relative other values in the market, a mean value within the market, etc. Such benchmarks can be established from historical and competitive data collected relating to the plan market's domain. Statistical methods and other techniques can also be applied to determine benchmarks for a particular input driver or outcome measure. Further, input driver (or outcome measure) values can be designated as being fixed at certain benchmark thresholds, for instance, through a rule or guide that a particular input driver's value not fall below a top 3 rank among competitors, not fall below a median or mean value, or fall to a worst in class designation, among other examples. In the particular example of FIG. 8A, benchmarking guidance for values of an example Market Share input driver 805 can define a number of benchmarks including a worst in class value 810, median value 815, and best in class value 820. Further, ranking benchmarks can be defined, for instance, input driver 805 values of 31% market share can be defined as claiming a third place competitive rank 825 among other competing organizations, departments within the same organization, or other competing entities.

Turning to the example of FIG. 8B, a simplified block diagram 800b is shown representing example feasibility bounds guidance for a channel coverage input driver 830 of an example plan model. Feasibility bounds guidance can model or define assumptions and constraints that should be enforced or otherwise guide values of the corresponding input driver. For instance, feasibility bounds guidance can model upper bounds or lower bounds of a particular input driver value. In the example of FIG. 8B, a lower bound 835 of 10% coverage is set for values of the example channel coverage input driver 830 and a value of 40% is set for the upper bound 840. Feasibility bounds can correspond to limits, either actual, desired, or predicted, on the acceptable or feasible values of an input driver within the context of a particular domain. Other feasibility bounds can also be defined, for instance, with some bounds representing a conservative feasibility estimate and a second set of bound representing a more generous or optimistic feasibility estimate. Further feasibility bounds can be combined, in some implementations, with benchmarking guidance to set bounds that correspond with a particular benchmark, such as a worst in class rating, best in class rating, particular competitive rank, etc.

Input driver and outcome measure guidance can be used to alert or deny a user attempting to change or modify corresponding values in the use of a plan model. Additionally, input driver and outcome measure guidance can be used to define default or starting values for instances of a particular plan model. Guidance rules can be enforced to constrain or limit the ability of particular values to be entered for corresponding input drivers and outcome measures, or alternatively, can provide guidance (e.g., through GUI presentations) indicating whether proposed values (or which values) comply or do not comply with a guidance rule for the input driver or outcome measure (e.g., but not limiting the ability of the value to be applied to the plan model, in some instances). In general, input driver and outcome measure guidance provide metrics and constraints corresponding to real world decisions, factors, and inputs involved in a domain as well as the goals of the domain modeled through a respective plan model. Further, as with the values of input drivers and outcome measures, and attributes of the plan model (e.g., scope model definitions, member models, etc.), users can also have control over the defined limits, rules, and guides within input driver and outcome measure guidance of a plan model, allowing users to adjust the plan model to change assumptions as well as allowing users to perform hypothetical modeling using different guidance rules, and so on.

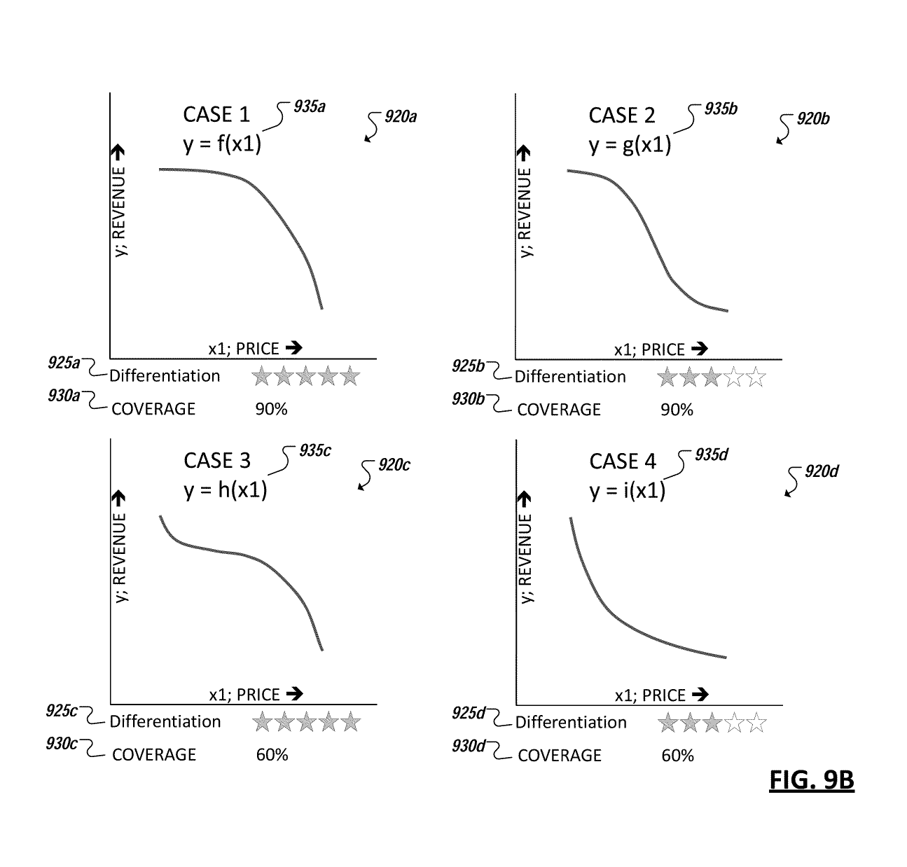

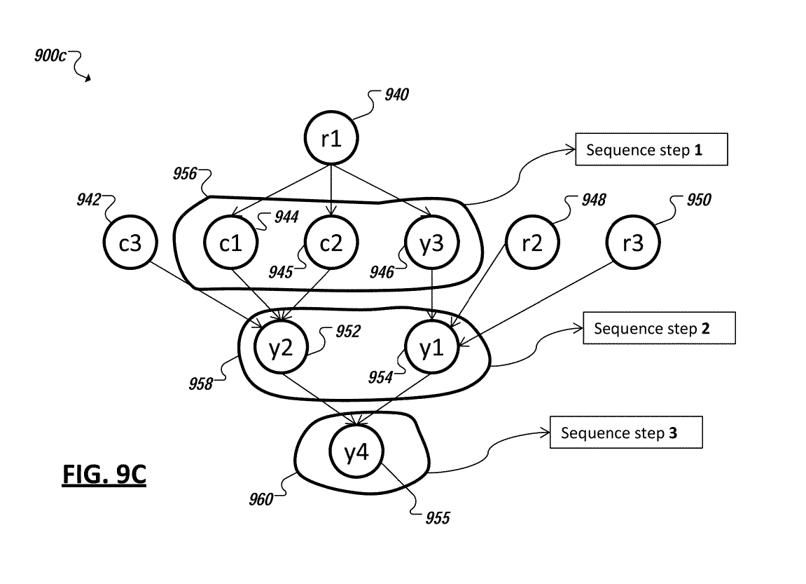

Planning and outcomes within a domain can be further modeled based on the domain-specific relationships between input drivers and outcome measures defined for the domain in a plan model. Turning to the example of FIG. 9A, a simplified block diagram 900a is presented representing an example implementation of a sensitivity model 905 included in a plan model. Sensitivity models 905 can model the sensitivity of various outcome measure values on changes to the values of one or more input drivers specific to the corresponding domain of the respective plan model. Further, sensitivity models 905, in some implementations, can additionally model aggregation relationships, including logic and formulas for calculating how an input driver value or outcome measure value can be disaggregated or split among member groups at varying levels of aggregations. Still further, in some instances, some input driver values can be at least partially dependent on other input driver values and, similarly, outcome measure values can be at least partially dependent on other outcome measure values. Accordingly, sensitivity models can further model these dependencies and sensitivities between values of input drivers on other input drivers and outcome measures on other outcome measures.

In one illustrative example, plan model sensitivity models 905 can include a propagation model 910 and one or more correlation models 915. A propagation model 915 can define a propagation sequence for how changes to defined input driver values (or outcome measure values) affect other input drivers' and outcome measures' values. The propagation sequence can define an order or path for how value changes cascade through other related input drivers and outcome measures. Correlation models 915 can be specified for each input driver and/or outcome measure and specify the function(s) and/or algorithm(s) used to compute how values of an outcome measure relate to, depend on, and are sensitive to values of the outcome measures and/or input drivers that influence its value. Respective correlation models 915 can model particular sensitivities and dependencies of all input drivers and/or outcome measures in a plan model. Further, all or a portion of a correlation model can be generated through automated techniques, including the use of data mining (to discover trends and relationships between market entities), regression analysis, design of experiments, and other analysis methods, among other example techniques.

Turning to the example of FIG. 9B, a set of graphs 920a-d representing an example portion of a correlation model modeling the multi-dimensional dependence of a single outcome measure on multiple input drivers. The correlation model can additionally model the dependence of input drivers on outcome measures (and other input drivers). Indeed, a correlation model can treat both input drivers and outcome measures as arguments of a function that represents a relationship between any one input driver or outcome measure. For instance, in the present example of FIG. 9B, a portion of a correlation model is represented of a relationship, or dependency, of values of an outcome measure Revenue (represented along the y axes of graphs 920a-d) on values of an input driver Price (represented along the x axes of graphs 920a-d). The example Revenue outcome measure can be further based on values of other input drivers including a Product Differentiation input driver (e.g., 925a-d) and Channel Coverage input driver (e.g., 930a-d). For instance, as shown in the example of FIG. 9B, the relationship between Revenue and Price can be based on a first formula 935a when the value of Product Differentiation 925a indicates a high level of product differentiation and the value of Channel Coverage is 90%, the formula 935a indicating that revenue decreases slowly as price increases (e.g., suggesting that demand is less sensitive to price increases when high product differentiation and channel coverage exist). Further, when product differentiation 925b is average but channel coverage is high, the relationship between Revenue and Price can be defined by a different formula 935b, as shown in the graph 935b, illustrating how values of other input drivers (e.g., 925a-d and 930a-d) can affect the relationship and sensitivity (i.e., dependence) of one particular outcome measure on one particular input measure, as further shown in the graphs 935c-d of formulas 935c-d.

The formulas and algorithms embodied and defined in sensitivity models can capture complex dependencies between outcome measures and input drivers, including multi-dimensional dependencies such as in the example of FIG. 9B. For instances, in some examples, a dependency can involve a lead time between a change in an input driver value and changes to values of input drivers and/or output measures dependent on the input driver. Accordingly, in some examples, correlation models can include a lead time function or component as a part of the correlation model, a lead time function defining an amount of time for the impact of a change in an input driver to be observed in other input drivers or outcome measures, among other time-based dependencies on the input driver. As an example, an increase in Marketing Spend to run an ad campaign to increase product awareness can be modeled as creating a two-week delay before correlative changes are observed at an Awareness outcome measure representing the product awareness outcome. In short, correlation models can define algorithms and formulas at varying degrees of complexity to model the domain-specific dependencies between input drivers and outcome measures, as well as between input drivers and other input drivers and between outcome measures and other outcome measures.

In some implementations, a sensitivity model can additionally allow for some input drivers and/or outcome measures that do not have a corresponding correlation function. In such instances, a sensitivity model can allow for user inputs or other outside inputs to specify, temporarily or persistently, a value for the input driver or outcome measure. In still other instances, the lack of a defined corresponding correlation function can permit the sensitivity model to also define, temporarily or persistently a dependency or formula for defining or calculating the value, among other examples. Further, the relationships and formulas underlying correlation models can be automatically generated through statistical modeling and analysis of data relating to input drivers and outcome measures of the domain.

Turning to FIG. 9C, a simplified block diagram is shown illustrating principles of an example propagation model of an example plan model. Generally, a propagation model can specify, for each input driver or outcome measure of a plan model, the sequence of how changes to values of the specific input driver or outcome measure propagate to affect values of other input drivers and outcome measures in the plan model. Indeed, propagation models can be generated from or based upon (and in some cases, automatically generated from) a collection of correlation models defining the interrelationships of the input drivers and outcome measures of the plan model. Further, a propagation model can additionally enforce constraints to prevent circular references and other conditions. Additionally, propagation models can be used to dictate events allowing or requesting user inputs, such as in instances where an input driver (or outcome measure) is identified in a propagation sequence that lacks a correlation model, among other examples. Additionally, visual representations of a propagation sequence can be generated from propagation models for presentation on a display device to users, for instance, in connection with a scenario planning session based on a corresponding plan model, among other examples.

In the particular example of FIG. 9C, an example propagation sequence is illustrated as modeled by an example propagation model. As another illustrative example, FIG. 9C includes a simplified block diagram 900c showing how a variety of different example outcome measures and input drivers can be interconnected within the context of a particular example plan model. Such example input drivers and outcome measures can correspond to such domain-specific variables, decisions, and outcomes as Profit, Revenue, Cost of Goods Sold (COGS), Spend, Sales Volume, Channel Coverage, Coverage Spend, Sales Incentive Spend, Product Differentiation, Price, among potential others. Consequently also, a web of potential propagation sequences (and correlation models) can be defined for the various interconnections and dependencies of values of input drivers and outcome measures represented in the particular example of FIG. 9C. For instance, Profit can be a function of Revenue, COGS and Spend; Revenue can be a function of Price and Volume; Volume a function of Coverage and Differentiation; and so on. Further, the propagation model of the example plan model can include logic that disallows situations where infinite loops of evaluation can occur, such as circular references. For instance, because Sales Incentive is a function of Profit, Profit is a function of Spend, and Spend is a function of Sales Incentive Spend in this example, the propagation model can halt, suspend, or otherwise guard against evaluation through an infinite loop due to this inherent circular reference between corresponding input drivers and outcome measures.

Turning to the example of FIG. 9D, a propagation model can define how a value or value change of a particular input driver (or outcome measure) propagates to and affects values of other input drivers and/or outcome measures. For instance, in the example of FIG. 9D, an example propagation sequence based on changes to values of input driver 940 can involve a plurality of other input drivers (e.g., 942, 944, 945, 948, 950) and a plurality of outcome measures (e.g., 946, 952, 954, 955). Other examples can include more or fewer input drivers and/or outcome measures, and in some instances, a single outcome measure or a single input driver, among other examples. In the particular example of FIG. 9D, the values of two other input drivers 944, 945 and an output measure 946 can be dependent on and affected by changes to the value of input driver r1 (940). This can be considered a first sequence step 956. As the values of input drivers 944, 945 and outcome measure 946 are at least partially dependent on input driver r1 (940), other input drivers and outcome measures (e.g., 952, 954) dependent on input drivers 944, 945 and outcome measure 946 can also be affected by the change to the value of input driver r1 (940). As input drivers and outcome measures can be dependent on values of multiple different other input drivers and outcome measures, subsequent sequence steps (e.g., 958) defining a propagation sequence for changes to the value of input driver r1 (940) can also be dependent on (and wait for) values of these other input drivers and outcome measures (e.g., 942, 948, 950). Some dependent input drivers (e.g., 944, 946) and outcome measures (e.g., 946) may only be a single sequence removed from the first input driver r1 (940), while others values are more removed within the propagation sequence, such as outcome measures 952, 954, 955 affected at second (958) and third sequence steps of this particular example propagation sequence.

It should be appreciated that the examples of FIGS. 9C and 9D (and other examples herein) are non-limiting examples provided merely for illustrating certain principles and features of this Specification. Propagation models (among the other models described herein) can be flexibly tailored to model any variety of propagation sequences involving any variety of combinations of input drivers and outcome measures commensurate with the modeling of particular outcomes of particular modeled domains.

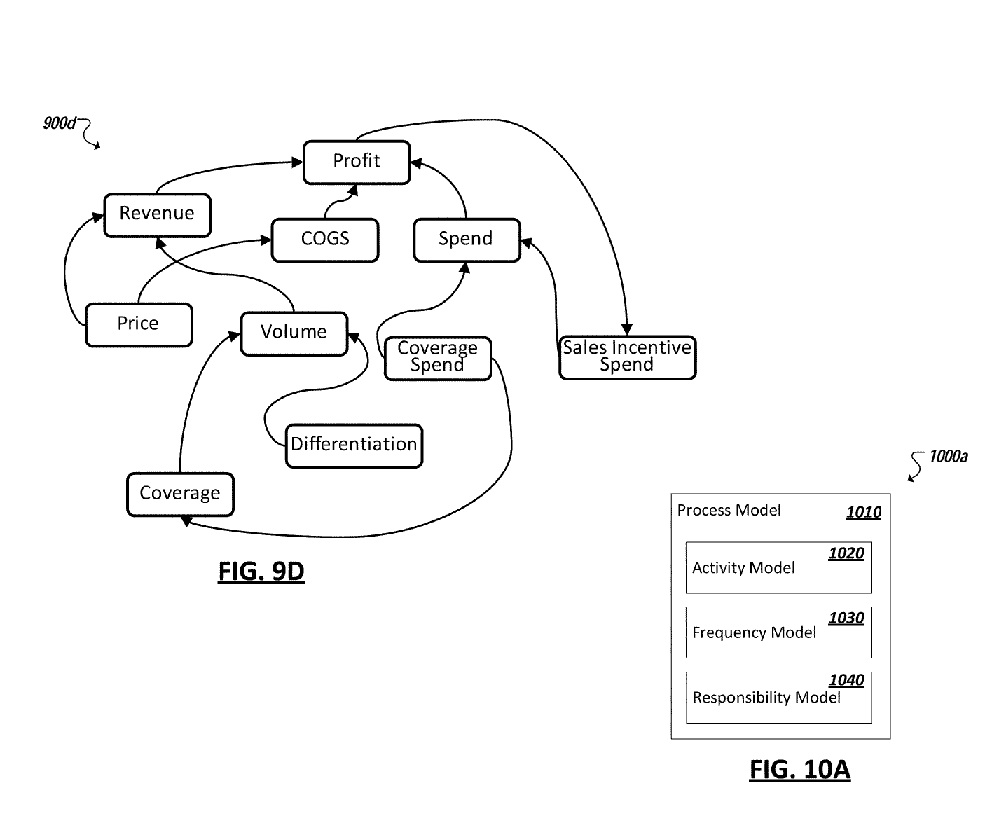

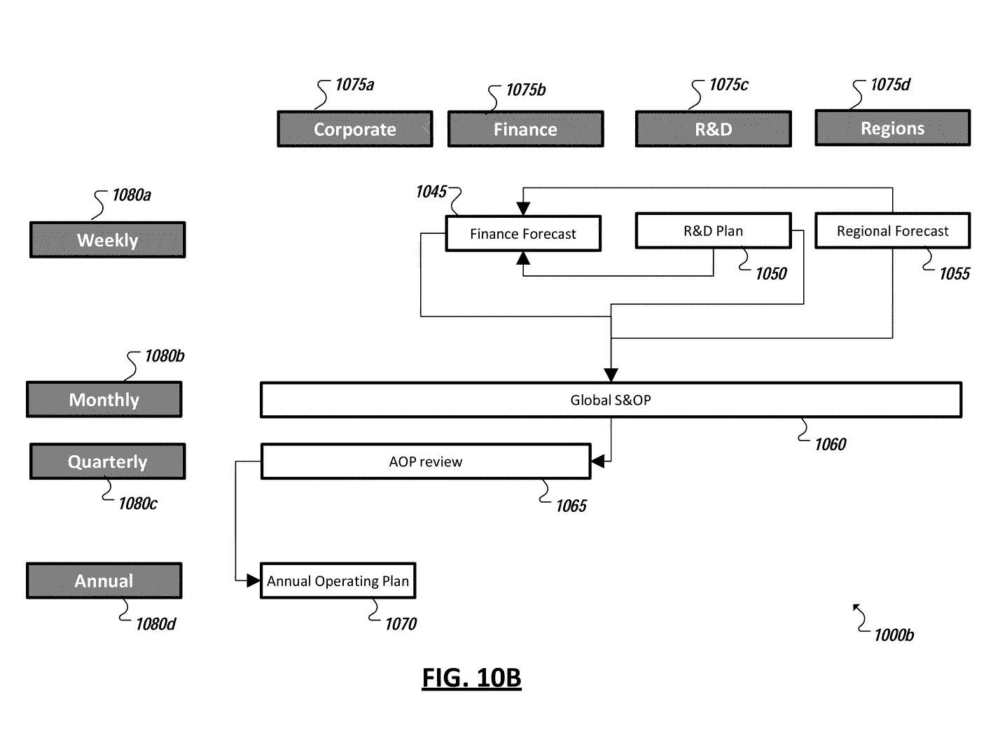

Turning to FIG. 10A, in some examples, in addition to including a scope model, input drivers models, sensitivity models, and outcome measures, a plan model can include other models used in the modeling of a domain's goals and enhancing use of the plan model itself, such as in scenario planning activities based on the plan model. In one example, as shown in the simplified block diagram 1000 of FIG. 10A, a plan model can further include a process model 1010 that further relates to the input drivers and outcome measures of the plan model. A process model, for instance, can specify the timing of planning activities designated for the corresponding plan model. For instance, in one example implementation, process models 1010 can include an activity model 1020, frequency model 1030, and responsibility model 1040, among potentially others. A process model 1010, in some instances, can be used to facilitate coordination between plan models of differing domains and potentially managed by different users by describing the various activities and tasks associated with the plan model, the timing of those activities (e.g., to assist in synchronizing use of the different plan models), and the users and parties responsible for those activities and/or the plan models themselves. In some implementations, a process model 1010 can adopt principles of responsibility assignment matrices, linear responsibility charts, and other protocols describing the participation by various roles in completing activities cross-functional and cross-departmental projects and activities, such as RACI, CAIRO, DACI-based process models, etc.

An activity model 1020 of an example process model can define planning activities of an organization relating to or using the plan model to which the process model 1010 belongs. An associated frequency model 1030 can define the timing of these planning-related activities, including the frequency at which the activities begin and end (e.g., daily, weekly, hourly, etc.), as well as more precise calendaring of activities that take place at less periodic intervals. With this information, planning activities involving multiple different plan models can be coordinated according to the respective planning activities defined for the respective plan models. In addition to activity 1020 and frequency models 1030, process models can further include a responsibility model 1040 identifying particular users, user groups, departments, etc. responsible for the planning activities described in the activity model 1020 as well as the plan model itself. Such models 1040 can be used as well in collaborative planning activities allowing users to identify other users responsible for other plan models linked to or otherwise involved in a planning activity, among other examples.

The example of FIG. 10B illustrates some principles and features enabled through example process models, such as the example process model shown and described in the example of FIG. 10A. For instance, in the simplified block diagram 1000b of FIG. 10B, a set of interconnected plan models 1045, 1050, 1055, 1060, 1065, 1070 are shown modeling outcomes in domains of an example organization such as finance forecast (e.g., 1045), research and development (e.g., 1050), regional forecasting (e.g., 1055), global sales and operation (e.g., 1060), adjusted operating profit review (e.g., 1065), and annual operating plan (e.g., 1070) among other potential plan models and other examples. Each of the plan models 1045, 1050, 1055, 1060, 1065, 1070 can have respective process models modeling activities using the corresponding plan model, such as the development of certain scenarios, such as a plan of record for the organization, or other planning activities. As represented in FIG. 10B, the process models of the plan models 1045, 1050, 1055, 1060, 1065, 1070 can identify particular departments or user groups (e.g., 1075a-d) that is responsible for the activity or to which the plan model belongs. Some plan models (e.g., 1045, 1050, 1055, 1070) can be belong to or be associated with a single department, while other plan models (e.g., 1060, 1065) are controlled by multiple departments in concert. For example, both a Corporate group 1075a and Finance group 1075b can be defined (in a corresponding process model) as responsible for generating a plan of record scenario (as well as other scenarios) using the AOP Review plan model 1065. Further, in addition to indicating an activity and a group (e.g., 1075a-d) responsible for performing the activity, process models can also define the timing of the activity. For instance, a plan of record scenario activity can be defined as being generated on a weekly basis (e.g., 1080a) for plan models 1045, 1050, 1055, monthly basis (e.g., 1080b) for plan model 1060, a quarterly basis (1080c) for plan model 1065, and annually (e.g., 1080d) for plan model 1070. The process models of interconnected plan models 1045, 1050, 1055, 1060, 1065, 1070 can thereby assist users in coordinating and managing activities that could potentially be impacted by or influence other plan models in the interconnected network of plan models, among other examples.

As noted above, a single plan model can be but a single plan model in a network of plan models for an organization (or group of organizations). Indeed, plan models can be adapted to be interconnected with other plan models in a network of plan models. As each plan model is tailored to a particular objectives and goals of a particular, defined domain, a network of interconnected plan models, each corresponding to a distinct domain, can provide a powerful system of software-based models enabling interactive, quick, collaborative decision making across the different plan models and, consequently, across multiple different, corresponding domains of an organization. Each plan model can independently model goals of its particular domain as well as be adapted to interconnect to other plan models to generate multi-domain scenarios and perform multi-domain planning activities using multiple plan models. In some implementations, process models of the respective plan models can assist in facilitating such multi-plan model activities.

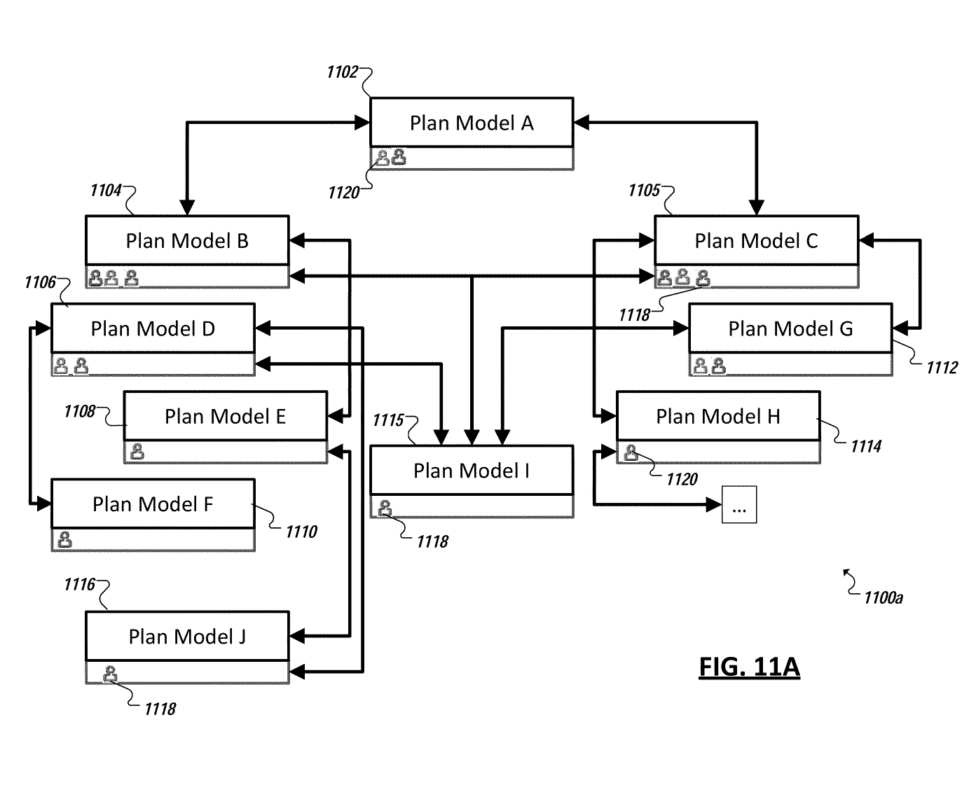

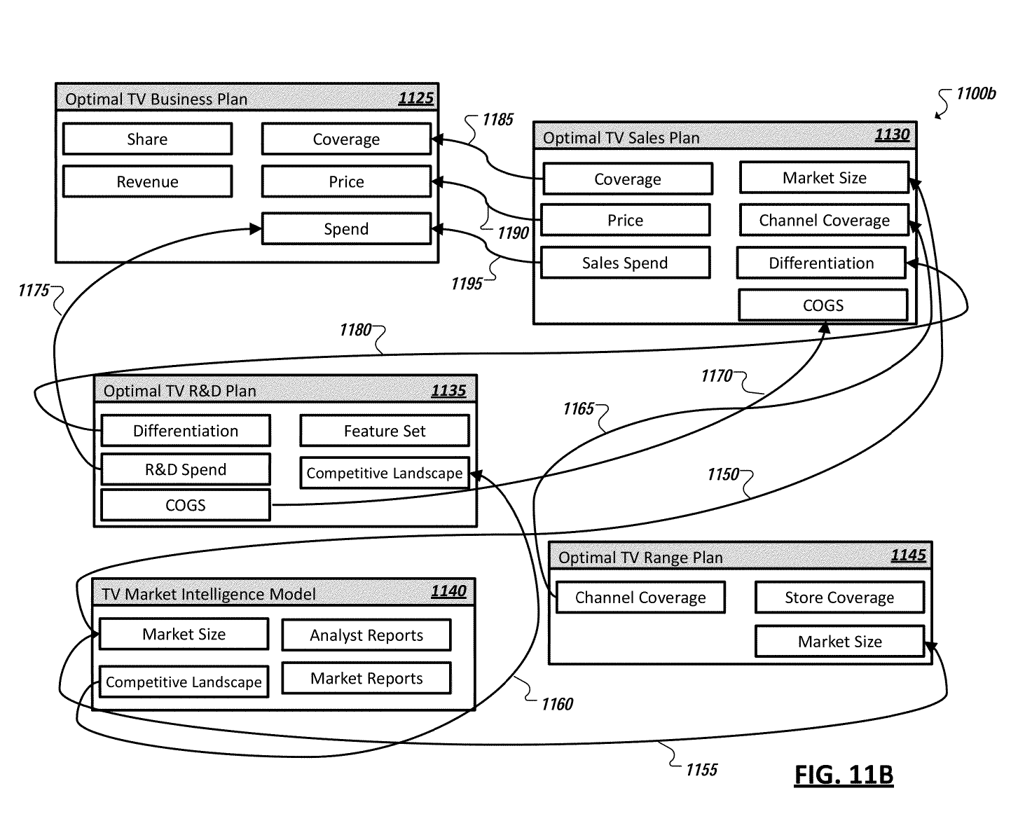

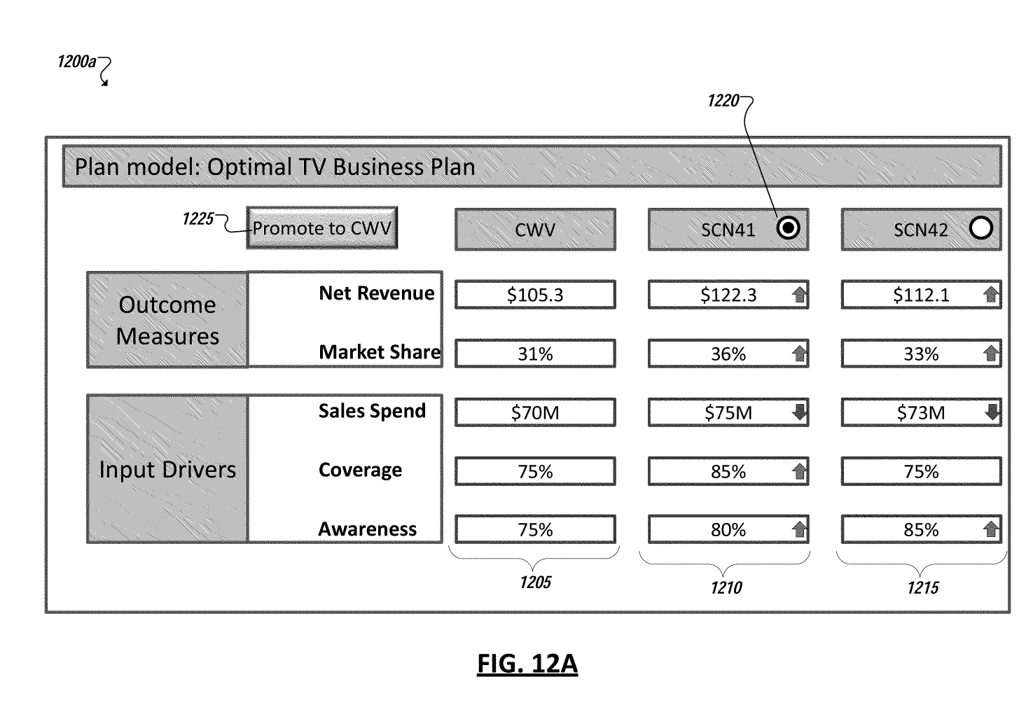

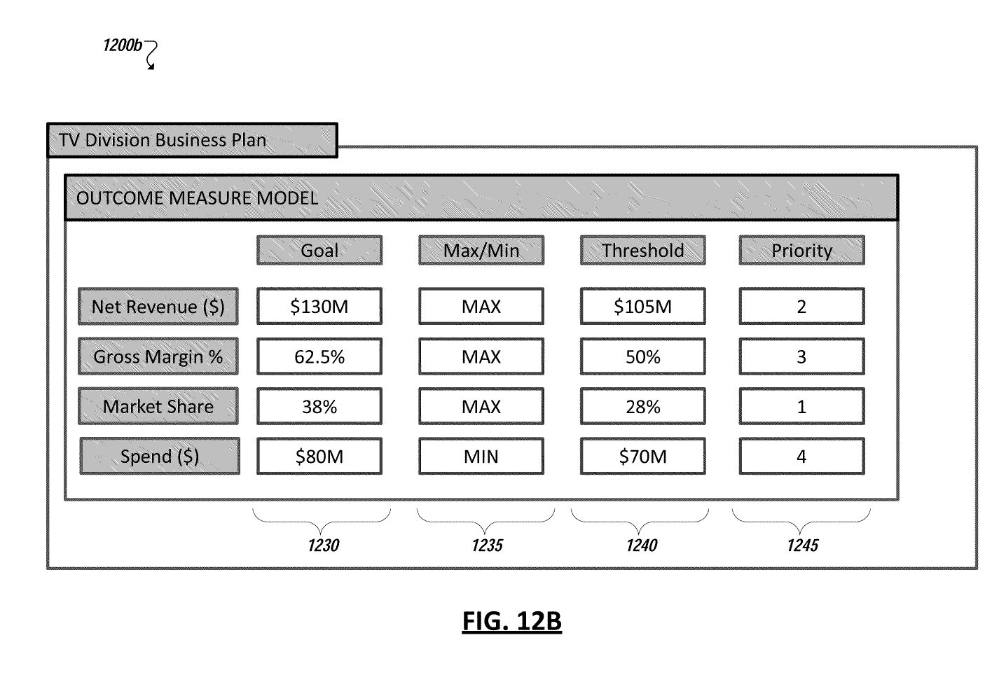

Turning to the example of FIG. 11A, a simplified block diagram is shown representing a network 1100 of plan models (e.g., 1102, 1104, 1105, 1106, 1108, 1110, 1112, 1114, 1115, 1116). Plan models in the network 1100 can be interconnected with one or more different other plan models in the network 1100 based on one or more input drivers of the plan model being dependent on one or more outcome measures (or even input drivers) of another plan model in the network 1100. Further, a plan model in the network 1100 can also be interconnected with other plan models in the network 1100 by virtue of an outcome measure (or input driver) of the plan model driving values of input drivers of the other plan model. Each plan model in the network 1100 with respective included scope models, input drivers models, outcome measures models, sensitivity models, process models, etc. The respective models of each plan model in the network 1100 can be tailored to model outcomes for a particular, distinct domain within the network, including representative scope models, sets of input drivers and outcome measures, etc.

Further, different users (or groups of users) (e.g., 1118, 1120) within an organization (or organizations) of the network 1100 of plan models can be assigned to or associated with particular plan models in the network 1100. Such associations can be based, for instance, on the users' respective roles, office locations, departments, etc. within the organization, with particular plan models being made available to those users corresponding to the particular defined domain of the respective plan model. As a simplified example, a particular user can be a manager of a particular department of an organization that is responsible for one or more different product lines. As the particular user 1118 can be responsible for managing, planning, and making decisions within this particular realm of the organization, the particular user 1118 can be associated with plan models that relate to the user's role, such as plan models (e.g., 1105, 1115, 1116) with domains corresponding to the particular department or constituent product lines of the user. Being associated with the plan models can authorize access and use of the respective plan models 1105, 1115, 1116 associated with the user in some instances. Other users not associated with the plan models 1105, 1115, 1116 may be blocked or limited in their ability to access and use the plan model 1105, 1115, 1116. However, other users (e.g., 1120) can be associated with other plan models (e.g., 1102) with domains more pertinent to their role within an organization. Some users can be associated with multiple plan models based on their role(s) within the organization, among other examples.

Dependencies between values of outcome measures (or other input drivers) of one plan model and input drivers (or outcome measures) of another plan model can be defined through link expressions. Link expressions can be specific to a single input driver-outcome measure pair (or input driver-input driver or outcome measure-outcome measure pair) of a plan model and define such aspects of the relationship as the algorithms and functions determining the sensitivity and dependence of the input driver on the outcome measure (e.g., analogous to correlation models of plan models' individual sensitivity models), as well as aggregation and disaggregation relationships (i.e., allowing modeling of the effects of inter-plan-model dependencies at their respective levels of aggregation), filter conditions applicable to the input driver-outcome measure pair, and so on. Linking expressions can further utilize established dimension- and attribute-based relationships between members of two or more different plan models linked through the link expressions.

Linking of plan models can allow for analysis of one or more plan models as the focus of a planning activity (e.g., the “focus plan models” of the planning activity), based at least in part on the dependencies of the focus plan models on other plan models to which they are linked through link expressions (or the “linked” plan models of the focus plan models.

FIG. 11B illustrates one potential example of link expressions (e.g., 1150, 1155, 1160, 1165, 1170, 1175, 1180, 1185, 1190, 1195) between example plan models (e.g., 1125, 1130, 1135, 1140, 1145) in a network 1100b of plan models. In the example of FIG. 11B, input drivers of each of the represented plan models 1125, 1130, 1135, 1140, 1145 are listed in a right column and outcome measures in a left column. For instance, example Optimal TV Business Plan plan model 1125 can include input drivers Coverage, Price, and Spend while including outcome measures Share and Revenue. As further illustrated by FIG. 11B, inputs drivers of the example Optimal TV Business Plan plan model 1125 can be based on outcome measures of other plan models. For instance, values of Coverage input driver of example Optimal TV Business Plan plan model 1125 can be dependent on a Coverage outcome measure of example Optimal TV Sales Plan plan model 1130, the dependency defined through a link expression 1185. Similarly, the Price input driver of plan model 1125 can be dependent on a Price outcome measure of plan model 1130 and the Spend input driver of plan model 1125 can be dependent on multiple outcome measures (Sales Spend and R&D Spend) of two different plan models (e.g., 1130, 1135), with respective link expressions (e.g., 1195, 1175) defining the dependencies between the respective input drivers and outcome measures.

Continuing with the discussion of FIG. 11B, an example plan model (e.g., 1130) can serve as a focus plan model in one activity and as a linked plan model in another activity (e.g., where one of the example plan model's linked plan models is the focus plan model). For instance, while input drivers of plan model 1125 are represented as dependent on outcome measures of Optimal TV Sales Plan plan model 1130, the Optimal TV Sales Plan plan model's 1130 may itself be dependent on values of other plan models in the network 1100b, such as defined by link expressions 1150, 1165, 1170, 1180, among other examples.

Link expressions (e.g., 1150, 1155, 1160, 1165, 1170, 1175, 1180, 1185, 1190, 1195) can interconnect example plan models (e.g., 1125, 1130, 1135, 1140, 1145) in a network 1100b of plan models and further enable scenario planning, analyses, and other uses across multiple plan models. This can further enable users of the network of plan models to cross-collaborate and plan across multiple, corresponding domains within an organization. For instance, link expressions (e.g., 1150, 1155, 1160, 1165, 1170, 1175, 1180, 1185, 1190, 1195) between plan models (e.g., 1125, 1130, 1135, 1140, 1145) can enable an ask-response collaboration protocol within the network of plan models as well as automated network propagation between multiple plan models in the network 1100b.

An example ask-response collaboration protocol can enable the setup of process workflow parameters within a given organization that is based on at least two different plan models in a network of plan models. Such workflow parameters can include, for instance, a due date for response, owner of a request, owner of response, etc. In ask-response collaboration, a focus plan model can request or provide a particular target value for one or more target outcome measures of a corresponding linked plan model. In response, the linked plan model can provide a response with feedback concerning the feasibility of the target value and effects of applying the target value to its targeted outcome measure based on its plan model. In this manner, one department or business unit of an organization can collaborate with and solicit input from other departments (and corresponding plan models) in the scenario building, planning, and other uses of their own plan models.

To illustrate, in one particular example corresponding to the example of FIG. 11B, Optimal TV Business Plan plan model 1125 can be the requesting focus model in a planning activity and one or more linked plan models (e.g., 1130, 1135) of the Optimal TV Business Plan plan model 1125 can be identified. The Optimal TV Business Plan plan model 1125 can “ask,” through an example ask-response-consensus protocol, that Price for a given television product be set, for instance, to $1000 in the United States (i.e., specifying a value corresponding to a particular level of aggregation for the plan model 1125 (e.g., the type of television and market region, etc.). A corresponding linked plan model, Optimal TV Sales Plan plan model 1130, can be identified as the recipient of the “ask” and can be used to assess the feasibility of the requested $1000 value. Accordingly, Optimal TV Sales Plan plan model 1130 come back with a response, based on its plan model 1130 and the input driver(s) that would enable the realization of a $1000 value of its corresponding Price outcome measure. In some instances, plan model 1130 could attempt to set the provided outcome measure to the targeted value (e.g., $1000) and report back whether or not the value could be achieved and what input driver values would result in such a value. This can be achieved, for instance, by analyzing and computing, through regression algorithms, or other techniques, the values (or sets of values) of input drivers of the linked plan model that would result in the requested value for the linked plan model's outcome measure.

In some instances, the “response” by the Optimal TV Sales Plan plan model 1130 can indicate that whether or not the “asked” value is obtainable as well as the consequences of adopting such a value across not only the Optimal TV Sales Plan plan model 1130 but also linked plan models (e.g., plan models 1135, 1140, 1145) of the Optimal TV Sales Plan plan model 1130 itself. Based on the feedback of the “response,” a “consensus” value can be derived, in some instances through iterative ask-response exchanges between the plan models 1125, 1130, until a value is settled upon for Price that is agreeable to both the Optimal TV Business Plan plan model 1125 and the Optimal TV Sales Plan plan model 1130 (as well as, potentially, other plan models in the network linked to the Optimal TV Business Plan plan model 1125 and/or the Optimal TV Sales Plan plan model 1130), among other examples.

As noted above, because input drivers of a linked plan model (e.g., 1130) in an ask-response exchange can themselves be dependent on outcome measures of other plan models (e.g., 1135, 1140, 1145) of the network 1100b, a request of a focus plan model (e.g., 1125) to a linked plan model (e.g., 1130) that is itself also a focus plan model, can result in a chain of ask-responses. In other instances, the requested linked plan model (e.g., 1130) can ignore, for purposes of providing a response to a focus model's request, its own dependencies on other plan model (e.g., 1135, 1140, 1145). However, more powerful and accurate modeling can be achieved by considering a larger chain of interconnected plan models, potentially modeling effects across an entire organization, business unit, or department having multiple related plan models. For instance, input drivers of a plan model 1130 can themselves be dependent on outcome measures of plan models 1135, 1140, 1145. In order to set values of the input drivers of plan model 1130 to respond to the “ask” request of plan model 1125 relating to a Price outcome measure, plan model 1130 can initiate its own series of ask-response exchanges with each of plan models 1135, 1140, 1145 to confirm the feasibility of values for input drivers Market Size, Channel Coverage, Differentiation, and COGS of Optimal TV Sales Plan plan model 1130 used as the basis of delivering a response to the original request from Optimal TV Business Plan plan model 1125 regarding the feasibility of a $1000 value for Price.

Given the interconnection of plan models, a single input driver or outcome measure of any given plan model can be considered dependent on values of other interconnected plan models' input drivers and outcome measures. In simple analyses, these dependencies can be ignored, however, as illustrated in the example above, a chain or sequence of link expressions can be leveraged to more completely model effects and dependencies across multiple plan models. Automated network propagation can automate this propagation of ask-responses across multiple plan models, for instance, with one user-generated ask from a first focus plan model (e.g., 1125) to a first requested linked plan model (e.g., 1130) prompting the automated generation of asks directed to other plan models (e.g., 1135, 1140, 1145) upon which the first linked plan model (e.g., 1135) is dependent as well as automating propagation of responses to these asks through the interconnected plan models to generate the ultimate response to the original ask (e.g., from plan model 1125). Automated network propagation can further enable and drive execution of goal-based scenario planning involving two or more linked plan models, including plan models within a network of plan models (e.g., 1100b), among other examples. Indeed, many other examples of ask-response exchanges and automated propagation between plan models are possible, not only within the context of this particular example, but generally across any conceived network of plan models, particularly considering the potentially infinite number of different plan models that can be developed to model various domains and the potentially infinite ways such plan models can be interconnected in plan model networks modeling organizations and other entities.

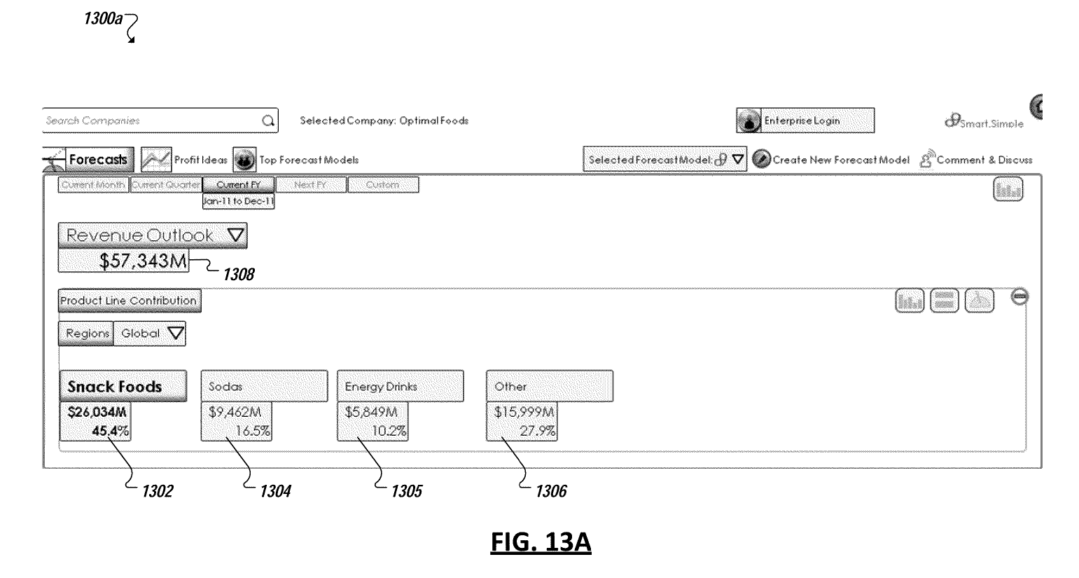

As discussed above, one or more plan models can be used in a variety of ways to model and analyze particular outcomes, goals, objectives, scenarios, and other characteristics of related domains. For instance, input driver scenario planning can be enabled through the use of one or more plan models. Turning to the example of FIG. 12A, a simplified block diagram 1200a is shown representing principles of an example scenario planning session involving one or more plan models (such as linked models in a network of plan models). Values of input drivers (or outcome measures) of a particular plan model can be set to any number of values or combination values, based, for instance, on the restraints set explicitly and inherently through the structure of the particular domain-specific plan model (e.g., through input driver and outcome measure guidance rules). Accordingly, multiple scenarios can be generated based on different versions of the same plan model(s), each scenario defined by the particular input driver values (and/or outcome measure values) set for that version of the plan model(s). Accordingly, plan model versions can represent a scenario capturing a set of plan model values and the effects (outcomes) generated from those values. Further, a given scenario can be developed from one or more plan models, saved, and identified by values such as a scenario name, date of creation, identification of the user(s) that created the scenario, a description of the scenario, and so on. Plan models that are recorded and archived in the generation of scenarios can be managed, in some implementations, through a plan version control model. The plan version control model can allow for analytics to be conducted on the various versions that are stored. The plan version control model can also provide for management that defines the number of scenarios that the system can simultaneously evaluate and compare, among other examples.

In the example of FIG. 12A, at least three scenarios 1205, 1210, 1215 have been developed based on the same set of one or more plan models. The plan model(s) upon which the scenarios 1205, 1210, 1215 have been based can include outcome measures Net Revenue and Market Share and input drivers Sales Spend, Coverage, and Awareness. As shown in the example of FIG. 12A, scenarios 1205, 1210, 1215 can have different defined input driver values for each of the combination of example input drivers Sales Spend, Coverage, and Awareness. Correspondingly, the respective outcome measures of the three scenarios 1205, 1210, 1215 can also be different. Alternatively, outcome measure values can be defined and input driver values derived that permit the specified outcome measure values, among other examples.

Through input driver scenario planning, users can be provided with interactive user interfaces presenting users with a view of the relevant input drivers and outcome measures of plan models used in the scenario planning that drive and model the particular scenario. In some instances, a scenario can only pertain to a subset of the available input drivers and outcome measures of the plan model(s) used in the scenario planning. Further, input drivers and outcome measures can be viewed at particular levels of aggregation available through the plan models and defined for the scenario planning. For instance, a scenario may be concerned with analyzing input driver values and responsive outcome measures for breakfast cereal in Germany, whereas the plan models used in the scenario planning model higher levels of aggregation, such as Food Products (e.g., of which breakfast cereal is one member group at a particular level of aggregation) and Worldwide Geographical Regions (e.g., of which Germany is one member group at a particular level of aggregation falling below a highest level of aggregation including all regions in the world), among other examples.

Input driver scenario planning can be utilized to allow users to manipulate values of a set of input drivers exposed by the plan models used in the scenario planning to observe effects on related outcome measure values. Input driver scenario planning can, in some instances, involve planning across multiple plan models, with modeling of at least some outcomes based on automated propagation of values of input drivers of a first plan model affecting input driver and outcome measure values of other plan models linked to the first plan model through link expressions, among other examples. In some instances, users can manipulate values iteratively in an attempt to realize what combinations of input driver values result in an optimal, hypothetical, or other desired outcome measure value(s). For instance, a user can be presented with a user interface (e.g., adopting a presentation similar to the example of FIG. 12A), and view values of input drivers and outcome measures of one or more scenarios as defined in one or more plan models used in the scenario(s). From the view, the user can manipulate one or more input driver values and observe how the manipulations affect values of the corresponding outcome measures of the scenario (e.g., 1210), as well as compare how the resulting scenario values compare against goals of the domain (e.g., as defined in a goal model of the plan model) or values set in other versions (e.g., 1205, 1215) of the same scenario. Further, in some implementations, a user may determine that underlying plan models or other factors cause incorrect or unrealistic outcome measures (or input drivers) to be generated in a scenario based on the plan models and may override one or more values manually, for instance, by providing a substitute value and marking the substitution as an override. Such manual overrides can then be used, in some implementations, as feedback for improving or correcting the plan models underlying the manipulated scenario.

Scenario planning can involve the definition of a particular scenario from one or more plan models, as well as the selection of input drivers and outcome measures of interest together with selected levels of aggregation for the values of the inputs drivers and outcome measures. In other instances, a scenario planning session can instead be based on a pre-existing scenario, such as a previously generated scenario or scenario template. For example, in some instances, the manager or user of a particular plan model or scenario can set a scenario with values representing a current working view of the user, user group, or organization. In one example, the current working view can represent the most ideal version of the scenario (and related plan models) yet realized during scenario planning. Consequently, in some examples, such as the example of FIG. 12A, a user can use a saved current working view scenario (e.g., “CWV” 1205) as the basis for a subsequent scenario, such as scenarios “SCN41” (1210) and “SCN42” (1215). A pre-existing scenario used as the basis for another scenario can be considered the “seed scenario” of the new scenario. The seed scenario can supply not only the basic structure of the scenario (e.g., the plan model, input drivers, outcome measures, levels of aggregations used, etc.) but also a set of default values, such as the values of input drivers and outcome measures defined in the seed scenario. Scenarios can also be generated “from scratch,” through the identification of one or more focus plan models and other parameters designating the levels of aggregation to be employed, the extent to which linked models should be considered, etc.

Continuing with the example of FIG. 12A, a current working view can serve as a common scenario used by potentially multiple users as the basis of a set of collaborative scenario planning sessions. A collaborative scenario planning session can be used to attempt to reach a consensus based on a comparison of a set of different scenarios potentially generated by a variety of different users, user groups, departments, etc. In some instances, input driver scenario planning can involve comparisons of two or more scenarios (e.g., 1205, 1210, 1215), including comparisons with a set current working view scenario (e.g., 1205), as illustrated in the example of FIG. 12A. Through the comparison, users can identify how scenarios compare, both in terms of the demands and decisions implied through input driver values of the respective scenarios 1205, 1210, 1215, as well as the outcomes realized in each scenarios. For instance, a user interface can be provided in connection with scenario comparison similar to the block diagram illustrated in FIG. 12A, with indicators being presented indicating how the values of the new scenarios compare against a current working view, for instance. As an example, the Sale Spend input driver value (e.g., $75M) of SCN41 (1210) is less favorable than that (e.g., $70M) set in a current working view scenario (e.g., because of the higher cost), while the values of outcome measures Net Revenue and Market Share of SCN41 (1210) are represented as more favorable in comparison with those of the current working view scenario 1205, among other examples.

A scenario can be promoted or reassigned as a current working view based on scenario planning, for instance, based on a determination that the new scenario (e.g., 1210 or 1210) is more favorable or desirable than the current working view scenario (e.g., 1205). For instance, in connection with a scenario comparison, such as represented in the example of FIG. 12A, a user can designate another scenario (e.g., through the selection go a radio button 1120 or other user interface control) and confirm (e.g., through button 1225 or another user interface control) that the designated scenario (e.g., 1210) should be promoted to the current working view, thereby replacing the previous current working view (e.g., 1205) in future comparisons or generations of new scenarios from the seed current working view scenario, among other examples. Scenarios can be designated or promoted in other ways as well. For instance, a scenario (such as a current working view or other scenario) can be set or promoted as a plan of record for an organization responsible for the plan model. A plan of record can define those input driver values and outcome measure values that the corresponding domain(s) will attempt to execute in their real world decisions, activities, and goals. In some instances, the promotion of a scenario to plan of record can be based on the reaching of consensus through collaborative scenario planning that the particular promoted scenario best meets the goals of the domain(s). In some instances, multiple versions of the same scenario seed can be set as the plan of record, for instance, to capture the timing with which the processes (associated with the plan model's domain) repeats itself, among other examples.

In addition to input driver scenario planning, goal-based scenario planning can also be enabled through the use of one or more plan models, as represented in FIG. 12B. Goal-based scenario planning can be utilized by users to automatically generate and present scenarios based on one or more specified goal values for outcome measures of one or more focus plan models. Accordingly, goal-based scenarios, rather than being input driver-driven can be based on changes or definitions to outcome measure values of plan models underlying the scenario(s). Applying principles similar to some of those described in connection with automated propagation with plan model networks, one or more goal values or value ranges for outcome measures of underlying plan models can be set (e.g., by a user) and serve as the basis for determining sets of input driver values that would realize, or at least approximate, if possible, the set goal values, based on the definitions of the underlying plan models, genetics and other algorithms and logic. Indeed, in instances where multiple sets of possible input driver values are identified as realizing a particular outcome measure goal, a plurality of distinct scenario versions can be generated corresponding to each set of possible input driver values. The resulting set of scenarios can then be compared, such as through a presentation similar to that in FIG. 12A, for instance, to determine and promote a most-desirable one of the generated scenarios, for example, to a current working view or plan of record, among other examples.

Goal values, in some instances, can include non-discrete values, such as in instances where the goal is to maximize or minimize a particular outcome measure value. In some instances, outcome measure guidance, as well as input driver guidance, defined in underlying plan models can be used in the setting of one or more goal values together with guiding and filtering the sets of input driver values derived to achieve the specified goal value(s). In the example of FIG. 12B, a simplified example user interface 1200b is presented in connection with an example goal-based scenario planning session. Through the user interface 1200b, a user can view and select a variety of values for a set of outcome measures included in the goal-based scenario, such as a Net Revenue outcome measure, Gross Margin outcome measure, Market Share outcome measure, and Spend outcome measure. Values (e.g., 1230) of the set of outcome measures can be manipulated in connection with the example goal-based scenario planning session, as well as values of outcome measure guidance rules and goal model parameters (e.g., 1235, 1240, 1245) provided through the plan models underlying the scenario. For example, a user can set a particular goal value (e.g., 1230), threshold values (e.g., 1235), minimization/maximization guidance (e.g., 1240, for instance, in the event the goal value 1230 of any one of the outcome measures cannot be reached), and relative priority guidance values (e.g., 1245) for any combination of the outcome measures. Based on the selections, one or more sets of corresponding input driver values can be returned, as well as, in some instances, generated scenarios incorporating the input driver values and additional feedback data, such as data indicating what input drivers, dependencies, other plan models, are preventing a particular goal value or set of goal values from being realized, among other examples. Additionally, as in input driver scenario planning, in some implementations, users may be provided with the additional option of manually overriding values of scenarios generated in response to provided goal values, for instance, to more accurately capture real world attributes of the domain modeled by the plan models underlying the scenario(s).

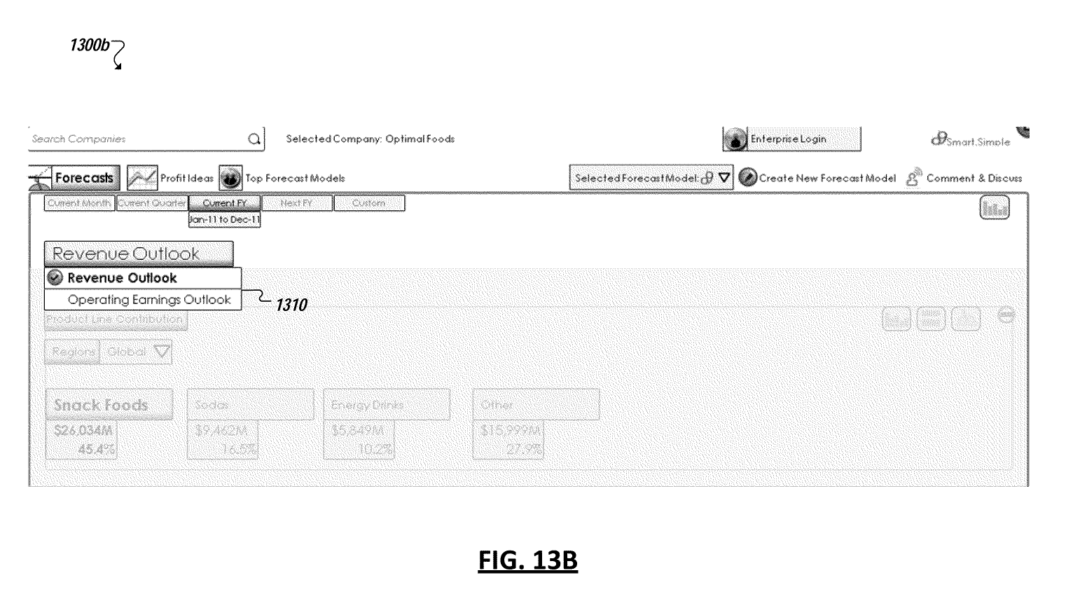

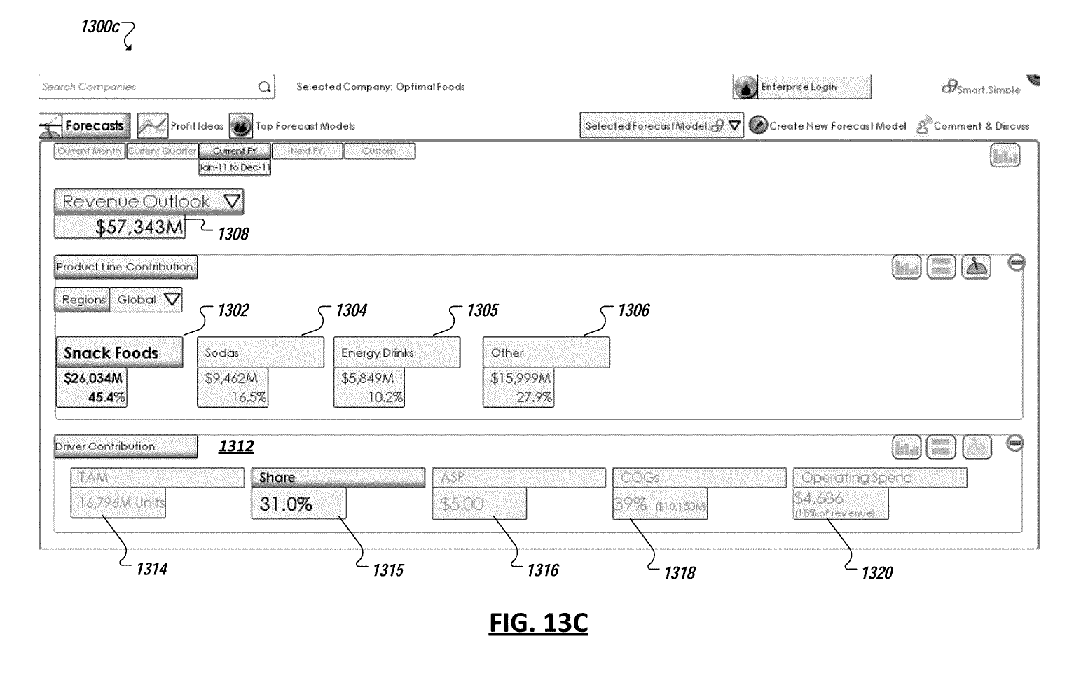

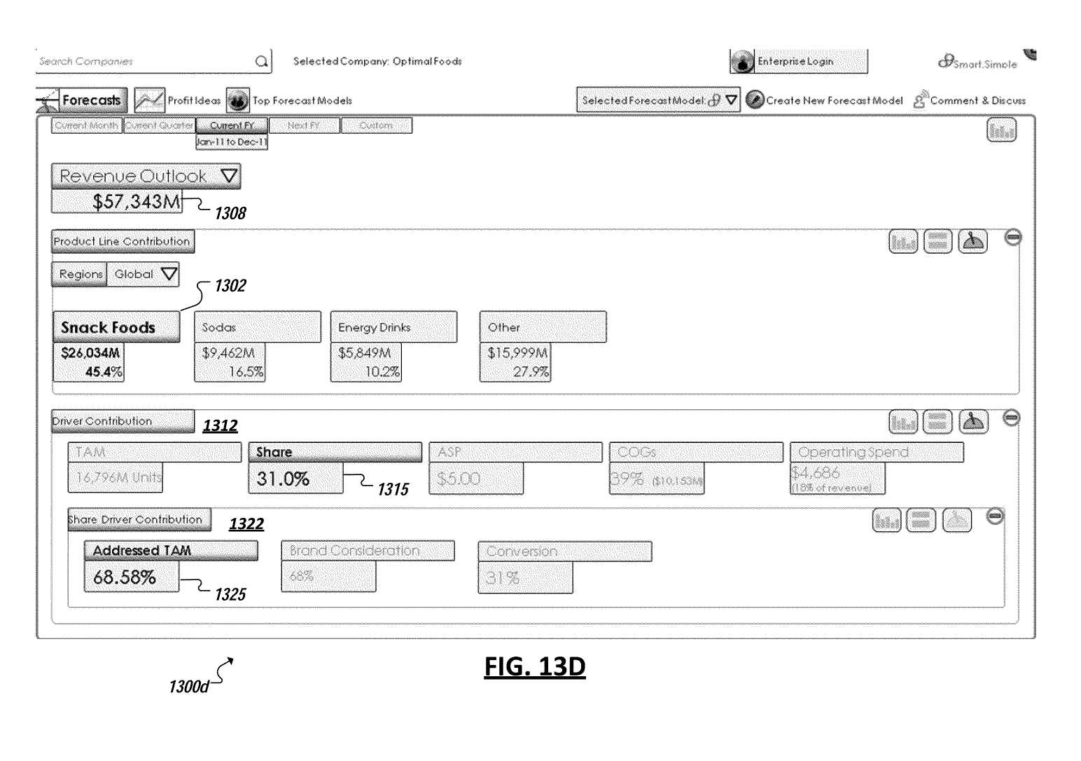

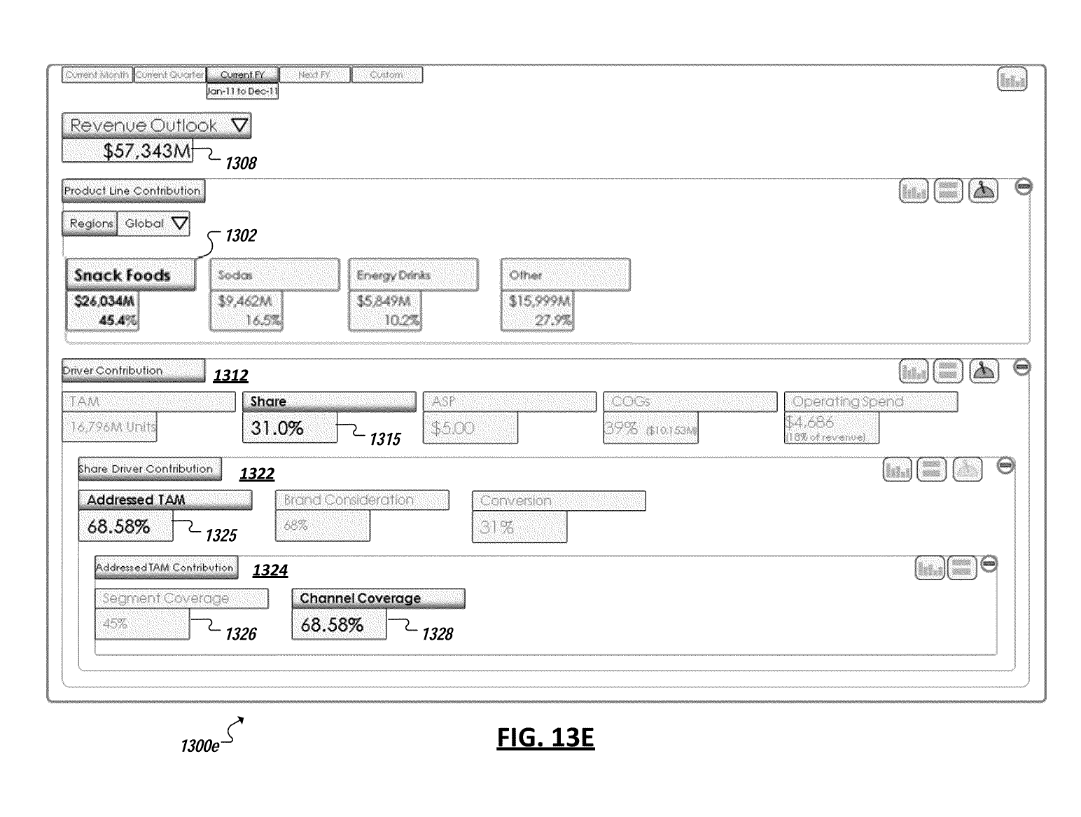

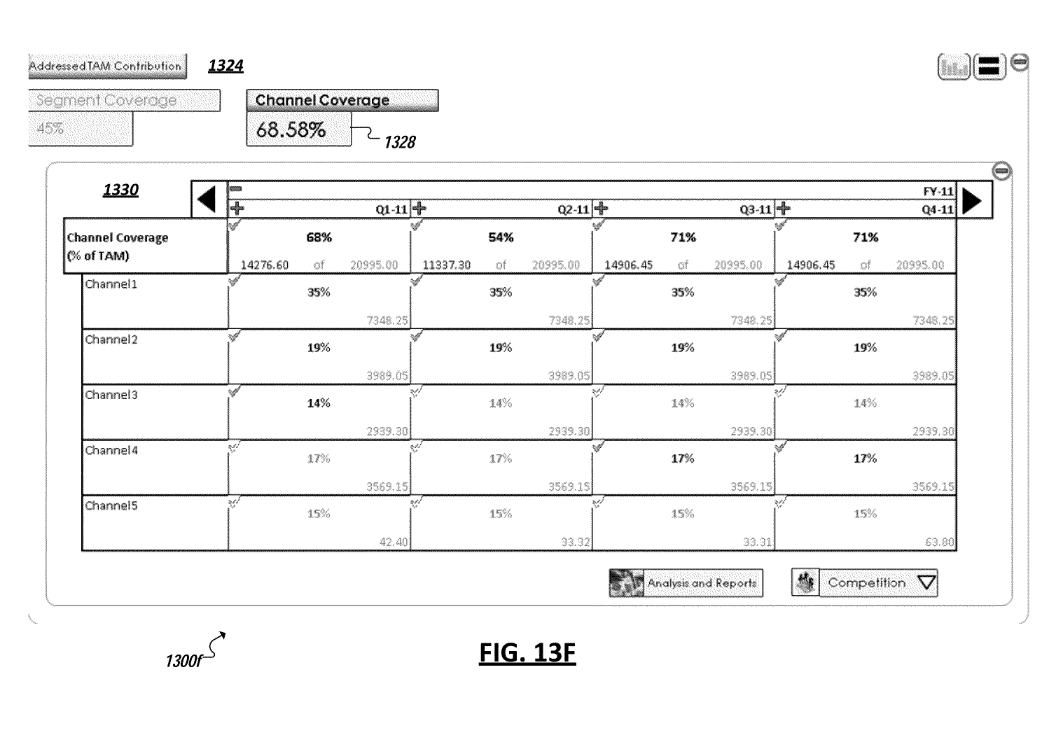

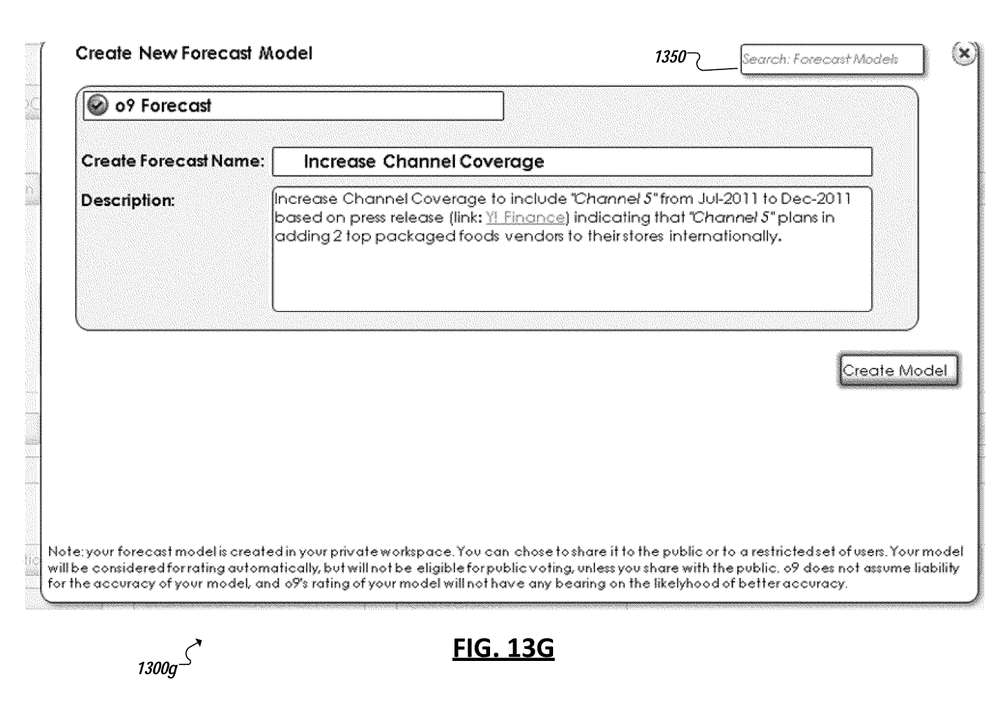

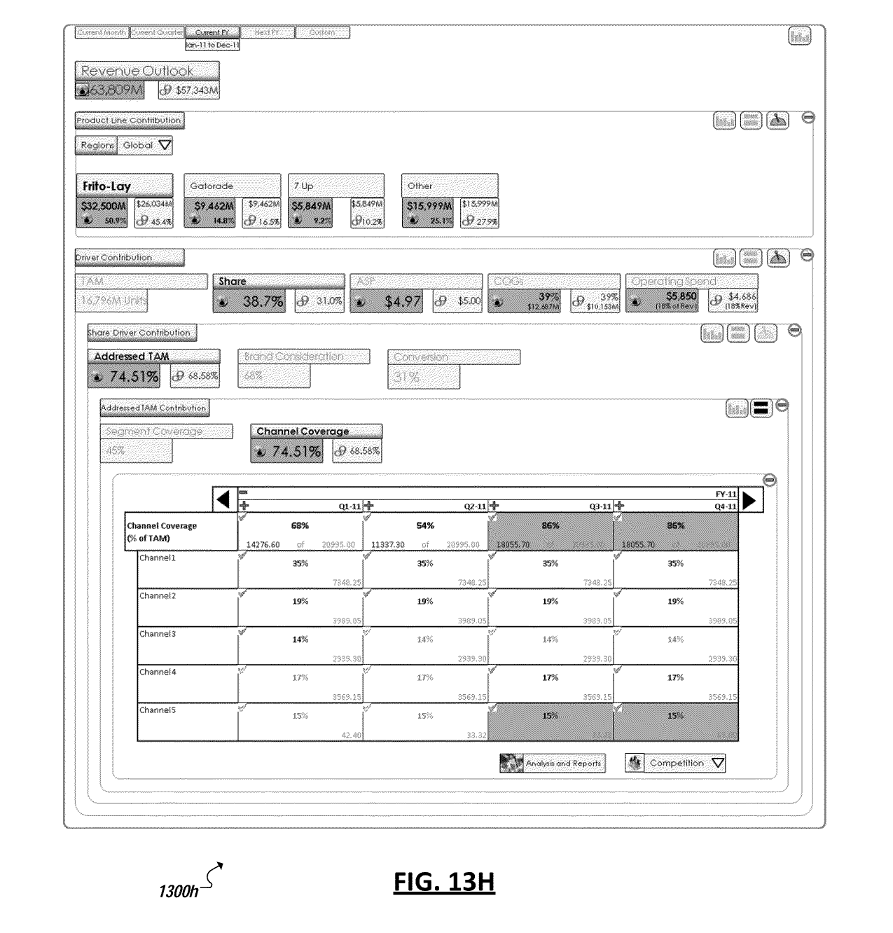

Turning now to the examples of FIGS. 13A-H, a set of example screenshots 1300a-h are presented illustrating additional examples and features in connection with plan models, plan model networks, and the use of such plan models (e.g., in scenario planning). Referring first to FIG. 13A, a screenshot 1300a of a user interface of an example planning system is shown. The planning system can be customized to a variety of different organizations and types of organizations and can apply and consume corresponding plan models of the organizations and their various respective domains. In the examples of FIGS. 13A-H, the planning system can be customized for a food company (e.g., “Optimal Foods”) with four divisions: snack foods, sodas, energy drinks, and miscellaneous food products. Accordingly, one or more plan models can be developed and used by the planning system that correspond to the four divisions. One of the plan models can include, for instance, an Optimal Foods Forecast plan model that will be referenced in the particular example screenshots of the examples of FIGS. 13A-H. The scope model of the Optimal Foods Forecast plan model can include a scope model with included entities such as Time, Product, and Region. Outcome measures of the Optimal Foods Forecast plan model can include Revenue Outlook and Operating Earnings Outlook, with input drivers including Snack Foods Revenue Outlook, Sodas Revenue Outlook, Energy Drink Revenue Outlook, and Other Revenue Outlook corresponding to the four divisions of the company. Accordingly, the user interface of the planning system can include windows, presentations, icons, fields, and controls corresponding to views of plan models, outcome measure values, input driver values, and other plan model-related views as exposed by the plan models of the planning system, as illustrated in the example screenshot 1300a of FIG. 13A. For instance, fields 1302, 1304, 1305, 1306 can correspond to values of the input drivers of Snack Foods Revenue Outlook, Sodas Revenue Outlook, Energy Drink Revenue Outlook, and Other Revenue Outlook input drivers and field 1308 can correspond to the value of a Revenue Outlook outcome measure defined in a particular scenario, such as a current working view or plan of record of the company. Further, turning to the example of FIG. 13B, further views can be exposed and presented through other controls of the user interface, for instance through a dropdown menu 1310 allowing a user to view details relating to one of the two outcome measures included in the plan model (or scenario) highlighted in the user interface view of screenshots 1300a-b, among other views, features, and examples.

As noted above, plan models can be linked to other plan models in a network of plan models allowing collaborative, inter-domain, and more comprehensive modeling of planning and goals within a multi-faceted organization. In the example of FIG. 13C, a Snack Foods Forecast plan model, corresponding to the example company's snack food division, can be linked to the company-wide Optimal Foods Forecast plan model, along with potential other plan models corresponding to the remaining company divisions. In this example, the Snack Foods Forecast plan model can include a scope model including entities such as Time, Product, and Region, outcome measures such as Outcome measures such as Revenue Outlook, Operating Earnings Outlook, and input drivers such as Total Available Market Size (TAM), Share, Average Selling Price (ASP), Cost of Goods Sold (COGS), and Operating Spend, among other examples.

In the screenshot 1300c of FIG. 13C, a user can select a particular one of the fields (e.g., 1302) corresponding to an input driver of the Optimal Foods Forecast plan model resulting in a new window 1312 being presented providing a view into a particular linked plan model (i.e., the Snack Foods Forecast plan model), corresponding to the selected input driver at 1302. The window 1312 can include additional fields 1314, 1315, 1316, 1318, 1320 corresponding to the input drivers of the linked Snack Foods Forecast plan model and display values of the input drivers that inevitably relate to the input driver values of Optimal Foods Forecast plan model (at 1302, 1304, 1305, 1306). From these views, a user can interact with the user interface fields 1302, 1304, 1305, 1306, 1314, 1315, 1316, 1318, 1320 to change particular values of the respective input drivers. Changes to the scenario underlying the presented graphical user interface (in screenshot 1300c) can also affect values of other linked or focus models in the network. For instance, changing one of values 1314, 1315, 1316, 1318, 1320 can lead to automated changes to the value in field 1302 (as well as to changes to other plan models to which the Snack Foods Forecast plan model is also linked). Indeed, as shown in the example screenshots of 1300d-e of FIGS. 13D and 13E, the Snack Foods Forecast plan model can be linked to a Snack Foods Share plan model which is itself linked to yet another plan model, an example Snack Foods Addressed TAM plan model. Further, views 1322, 1324 of the respective Snack Foods Share plan model and Snack Foods Addressed TAM plan model can be accessed through the respective selection of corresponding fields or controls 1315, 1325 (in FIGS. 1300d and 1300e respectively), and so on. Further selection of other fields (e.g., 1304, 1305, 1306, 1310, 1314, 1316, 1318, 1320, 1326, 1328) can open additional views corresponding to still other plan models or portions of plan models consumed by the example planning system.

User interfaces of an example planning system can provide additional views of information included in scenarios and underlying plan models, including views of values at varying levels of aggregation. Indeed, a user can select and toggle between different views displaying plan models at varying levels of aggregations defined for the domain(s) of the corresponding plan model(s). In one example, shown in the screenshot 1300f of FIG. 13F, a channel coverage input driver value of the example Snack Foods Addressed TAM plan model can be viewed according to a particular level of aggregation, such as presented in window 1330 of screenshot 1300f. For instance, the Channel Coverage value can be viewed at levels of aggregation corresponding to entities such as Time, Product, Region, and Channel. In the particular example of FIG. 13F, a view is displayed with Channel Coverage represented at a level of aggregation corresponding to a quarterly time period in the year 2011 and according to the particular individual channel members of the domain. A user can further interact with the window 1330, for instance, by modifying individual values of Channel Coverage for each of the displayed member groups, thereby possibly also changing values of plan models linked to outcome measures or input drivers of the Snack Foods Addressed TAM plan model or another model (such as a Channel Coverage plan model, among other examples).

Turning to the example screenshot 1300g of FIG. 13G, an example user interface is shown allowing a user to create, define, and name a new scenario for use, viewing, and manipulation in the planning system. In some examples, the new scenario can be generated from a seed scenario. Such seed scenarios can be searched for (e.g., through search field 1350) or otherwise identified and selected through additional user interfaces and user interface controls of the planning system. For instance, the scenario (and incorporated plan models) of the examples of FIGS. 13A-F can be used as a seed scenario and a user can manipulate the values of various fields corresponding to input drivers (and/or outcome measures) of the seed scenario to define a new version of the seed scenario. Additionally, as shown in the screenshot of FIG. 13H, guidance can be provided to a user showing the user a value of the seed scenario, current working view scenario, or other scenario, as well as values defined in guidance measures to assist the user in defining values for the new scenario. The user can then use the newly generated scenario is comparisons with other versions of the scenario and further modify or promote the scenario according to the desires of the user(s) through additional user interfaces, such as user interfaces adopting principles of the examples of FIGS. 12A-B, among other examples.

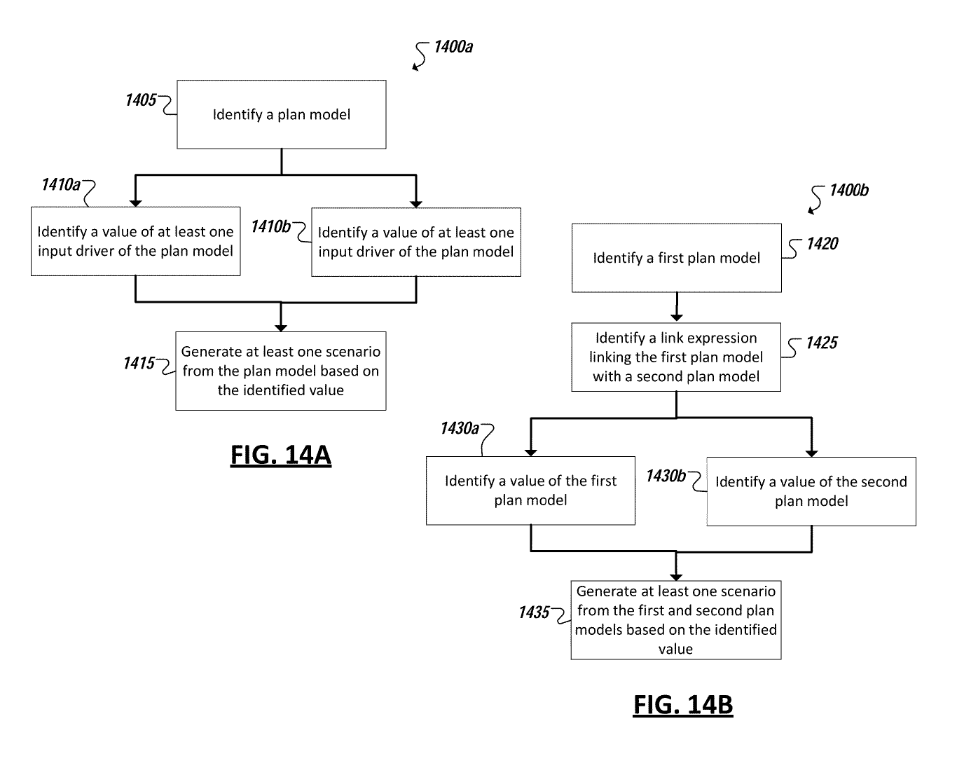

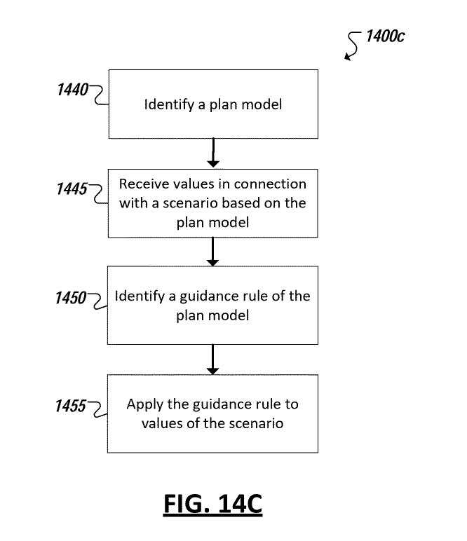

FIGS. 14A-C include simplified flowcharts 1400a-c illustrating example techniques for using plan models and networks of plan models, such as those shown and described in the examples above. In the flowchart 1400a of FIG. 14A, for instance, one or more plan models can be identified 1405, for example, in connection with a particular planning activity. Identification 1405 of the plan model(s) can include, for instance, specification or selection of the plan model by a user, application, or system. In some instances, selection of a seed scenario can include identification of the composite plan models of the selected seed scenario. In some instances, a plan model can be identified based on a link expression connecting one plan model with another, among other examples. Values for one or more input drivers (e.g., at 1410a) of the identified plan model or values for one or more outcome measures (e.g., at 1410b) of the identified plan model can be identified. Identification 1410a, 1410b of the values can include user- or system-specification of values, as well as identification of values from other plan models (e.g., through an ask-response protocol), goal models, and other components of an example planning system. Based on the identification or provision of input driver or outcome measure values (at 1410a or 1410b), other values of outcome measures and/or input drivers of the plan model (or multiple plan models) can be generated based on the respective sensitivity models and/or link expressions of the plan models to generate 1415 a scenario from the plan model based on the identified value (e.g., at 1410a or 1410b). The generation of scenarios 1415 can include input-driver-based scenarios or goal-based (e.g., outcome measure-based) scenarios that can be compared, saved, shared, promoted, etc. in connection with planning activities of one or more organizations.

Planning activities can include multiple linked plan models in a network of plan models. Turning to the example of FIG. 14B, a first plan model in a network of plan models can be identified 1420. In some instances, the identified first plan model can be identified 1420 as a focus plan model of a planning activity. One or more link expressions of the first plan model can be identified 1425 that link the first plan model to one or more other plan models, including a second plan model. In instances where the first plan model is a focus plan model, identification 1425 of a link expression to the second plan model can serve as the basis for identifying the second plan model as a linked plan model of the first plan model. Depending on the nature of the link expression defining the link between the first and second plan models, a value of an input driver (or outcome measure) of the first plan model can be identified 1430a which is linked to an outcome measure (or input driver) of the second, linked plan model. Alternatively, a value of an input driver (or outcome measure) of the second plan model can be identified 1430b which is linked to an outcome measure (or input driver) of the first, linked plan model (i.e., depending upon the linking of the first and second plan models). Identification 1430a, 1430b of values can include user- and system-specification of values, as in previous examples, in connection with scenario planning using the first and second plan models. Indeed, based on the provided or identified 1430a, 1430b value(s), at least one scenario can be generated 1435 from the first and second plan models and based on the identified values.

Turning now to the example of FIG. 14C, guidance rules can be applied to inform or constrain users' (or systems') submittals of values for input drivers and/or outcome measures of plan models during planning activities using the plan models. For instance, a plan model can be identified 1440 (e.g., in connection with a scenario generation based on the plan model) and values can be received 1445 (e.g., either for input drivers or outcome measures of the plan model) in connection with the generation of a scenario using the identified plan model. A guidance rule can be identified 1450 that applies to the received 1445 value(s). In some cases, guidance rules can be embodied or defined in the plan model itself, such as in an input drivers model or outcome measures model of the plan model. The guidance rule can then be applied 1455 to the values in connection with the generation of the scenario. Applying 1455 the guidance rules can include presentation of warnings, guides, feedback, and other indicators on graphical user interface showing how to comply or whether a value complies with a given guidance rule. In other instances, applying 1455 the guidance rules can constrain the ability of a particular value to be used in a scenario, with values violating the rule being rejected as valid values, among other examples. Further, example guidance rules can include, for instance, threshold guidance rules, benchmark guidance rules, feasibility guidance rules, priority guidance rules, among others, including those described elsewhere herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. Systems and tools illustrated can similarly adopt alternate architectures, components, and modules to achieve similar results and functionality. For instance, in certain implementations, multitasking, parallel processing, and cloud-based solutions may be advantageous. Additionally, diverse user interface layouts, structures, architectures, and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium can be a non-transitory medium. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

Networks, including core and access networks, including wireless access networks, can include one or more network elements. Network elements can encompass various types of routers, switches, gateways, bridges, load balancers, firewalls, servers, inline service nodes, proxies, processors, modules, or any other suitable device, component, element, or object operable to exchange information in a network environment. A network element may include appropriate processors, memory elements, hardware and/or software to support (or otherwise execute) the activities associated with using a processor for screen management functionalities, as outlined herein. Moreover, the network element may include any suitable components, modules, interfaces, or objects that facilitate the operations thereof. This may be inclusive of appropriate algorithms and communication protocols that allow for the effective exchange of data or information.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, which are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method comprising:
identifying one or more plan models, each of the plan models representing a business outcome of a corresponding domain and including a respective set of input drivers and a respective set of outcome measures, values of the outcome measures influenced by values of the input drivers;
receiving one or more particular values in connection with a scenario based on the plan models; and
applying one or more guidance rules defined through the plan models to values of the scenario.

2. The method of claim 1, wherein applying the particular guidance rule constrains the received value according to the particular guidance rule.

3. The method of claim 1, wherein applying the particular guidance rule includes presentation of an indication of a degree of compliance with the particular guidance rule.

4. The method of claim 3, wherein the indication is a warning of a violation of the particular guidance rule.

5. The method of claim 1, wherein applying the particular guidance rules includes presentation of an indication of a target value.

6. The method of claim 1, wherein the one or more particular values include a specified value of a particular one of the set of input drivers of a particular one of the one or more plan models and a particular guidance rule of the particular plan model is applied to the specified value.

7. The method of claim 6, wherein the particular guidance rule includes a feasibility guidance rule defining one of a lower bound or upper bound for values of the particular input driver.

8. The method of claim 6, wherein the particular guidance rule includes a benchmark guidance rule specifying at least one benchmark value for values of the particular input driver.

9. The method of claim 8, wherein the benchmark value includes at least one of a set including a best-in-class value, a median value, a worst-in-class value, and competitive rank values.

10. The method of claim 6, wherein the particular guidance rule includes a relative importance indicator for the particular input driver relative to at least one other input driver in the particular plan model.

11. The method of claim 1, wherein the one or more particular values include a value of a particular one of the set of outcome measures of a particular one of the one or more plan models and a particular guidance rule of the particular plan model is applied to the value of the particular outcome measure.

12. The method of claim 11, wherein the particular guidance rule includes a benchmark guidance rule specifying at least one benchmark value for values of the particular outcome measure.

13. The method of claim 12, wherein the benchmark value includes at least one of a set including a best-in-class value, a median value, a worst-in-class value, and competitive rank values.

14. The method of claim 1, further comprising defining parameters of the one or more guidance rules based on a received input.

15. The method of claim 14, wherein defining the parameters includes modifying previous parameters of the one or more guidance rules based on the received input.

16. The method of claim 1, wherein the plan model is a first plan model and linked to a second plan model, the scenario is based at least on the first and second plan models, and the guidance rules are applied to values of each of the first and second plan models.

17. The method of claim 16, wherein guidance rules of the first plan model are applied to values of the first plan model and guidance rules of the second plan model are applied to values of the second plan model.

18. An article comprising non-transitory, machine-readable media storing instructions operable to cause at least one processor to perform operations comprising:
identifying one or more plan models, each of the plan models representing a business outcome of a corresponding domain and including a respective set of input drivers and a respective set of outcome measures, values of the outcome measures influenced by values of the input drivers;
receiving one or more particular values in connection with a scenario based on the plan models; and
applying one or more guidance rules defined through the plan models to values of the scenario.

19. A computer program product, encoded on a tangible, non-transitory, machine-readable storage medium, the product comprising:
one or more plan models, each plan model adapted to model outcomes for a respective business domain and including:
an input drivers model defining input drivers of the plan model;
an outcome measures model defining outcome measures of the plan model; and
one or more guidance rules defining constraints on values of at least one of a particular input driver of the plan model and a particular outcome measures of the plan model.

20. The product of claim 19, further comprising:
a second plan model adapted to model outcomes for a second business domain; and
at least one link expression defining a dependency between the first plan model and the second plan model.

21. A system comprising:
at least one processor;
at least one memory element;
a plan model, stored at the memory element and adapted to model outcomes for a particular business domain, the plan model including:
an input drivers model defining input drivers of the plan model;
an outcome measures model defining outcome measures of the plan model; and
one or more guidance models defining guidance rules for values of at least one of a particular input driver of the plan model and a particular outcome measure of the plan model; and
a plan model engine adapted, when executed by the processor to:
generate scenarios based on the plan model; and
apply the defined guidance rules to the scenarios.
